(19) United States
(12) Patent Application Publication
(10) Pub. No.: US 2008/0208820 A1
(43) Pub. Date: Aug. 28, 2008

(54) SYSTEMS AND METHODS FOR PERFORMING SEMANTIC ANALYSIS OF INFORMATION OVER TIME AND SPACE

(75) Inventors: Robert W. Usey, Atlanta, GA (US); Don M. Simpson, Cumming, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PSYDEX CORPORATION, Atlanta, GA (US)

(21) Appl. No.: 12/039,712

(22) Filed: Feb. 28, 2008

Related U.S. Application Data
(60) Provisional application No. 60/892,162, filed on Feb. 28, 2007.

(51) Int. Cl. G06F 17/30

(52) U.S. Cl. 707/3; 707/E17.014

(57) ABSTRACT

Systems and methods for collecting, processing, analyzing, and indexing large amounts of data in such a manner that queries can be formulated and exercised against the data in an expedient manner. Embodiments of the present invention provide for static or dynamic presentation of the indexed data based upon the queries. The data organization and access techniques applied in embodiments of the present invention are structured in a way that allows for a large variety of queries to be performed on the data without having to reorganize the data. Additionally, indexes and presentations of the data are continually updated and modified in virtually real-time.

### CROSS REFERENCE TO RELATED APPLICATION

This application claims the benefit under 35 U.S.C. §119(e) of U.S. Provisional Patent Application No. 60/892,162, filed Feb. 28, 2007, and entitled “System and Method for Performing Semantic Analysis of Text Streams Over Time and Space,” which is incorporated herein by reference in its entirety.

### FIELD OF THE INVENTION

Embodiments of the present invention relate generally to providing for the collection, analysis, indexing, accessing, and displaying of data obtained from one or more sources. More particularly, embodiments of the present invention relate to methods and systems for ingesting, recording, tokenizing and indexing a plurality of information files and streams over time, aggregating and storing indexed information based on temporal, relational, and spatial proximity, and providing efficient, continuous query access and related outputs based on elements and groups of elements contained in the information files and streams.

### BACKGROUND OF THE INVENTION

Today, with resources such as the Internet, 24-hour television news feeds, and increased globalization of news and event reporting, thoughts and ideas are spread around the globe with a contagion effect. In addition to news and information being communicated via television, it is widely distributed over the Internet using sources such as Really Simple Syndication (RSS) and Web Logs (blogs). The impact of news stories such as an Avian influenza pandemic, SEC investigations of companies, and terrorist attacks cause people who view or hear such stories to react emotionally, often overreacting or, alternatively, failing to react at all. Symbols and words such as “pandemic”, “tornado warning”, “consumer recall”, “fraud”, and “child abduction” can cause powerful changes in emotions affecting feelings of security, stability and confidence. These emotional feelings often influence investment decisions, the overall public persona of companies or people, and civil actions or initiatives. Accordingly, the ability to effectively measure the sentiment, velocity, magnitude, momentum, and acceleration of cultural information and memes can be a powerful tool in highly analytic domains such as financial markets, national security, and intelligence.

Currently, analysts and researchers in these domains employ some combination of search tools and labor intensive analytic processes to examine and synthesize information. These tools and methods, however, lack the ability to easily assemble temporal (time series) or spatial views of subject matter covering many diverse sources of information in real time. While Internet search engines can serve up a daily snapshot or snippets of news and information, as time passes the historical context of the subject matter fades along with the ability to measure current memes against historical patterns and trends. This inability to quickly and effectively put current news in a historical context to better assess the magnitude, momentum and size of a meme creates gaps in the analytic process causing huge swings in related financial market activity or costing lives where emergency responders or security experts react to inaccurate information.

Further, particularly in the financial market arena, quick assimilation of breaking news stories can greatly affect successful financial trading. For instance, a breaking story about a pharmaceutical company pulling a highly profitable drug from the market because of FDA violations may cause that company's stock to drop drastically. However, if a trader or investor had access to that information virtually instantaneously as the story was released, that trader or investor may be able to trade the company's stock before the drop in value was realized. Moreover, if the magnitude or influence of that story could be valued against a history of previous, similar stories, the investor would be even more informed as to expected movement of the stock, and could act accordingly.

Therefore, a long-felt but unresolved need in the art is a technology and services platform that translates the world's unstructured news and information sources into data outputs and streams that represent quantitative measures of subject matter over time and space. Further, there is a need in the art to bring order to the mass of chaotic chatter swirling around the world thus enabling users and automated systems to easily analyze and reason over historical patterns and trends in communications.

### BRIEF SUMMARY OF THE INVENTION

Briefly described, and according to one embodiment, the present invention is directed towards a system for performing semantic analysis on data. The system includes a plurality of collectors for collecting observations emitted from a plurality of sources. Once collected, the observations are processed by a plurality of data ingest components that transform the observation attributes from source-specific formats into a general system format, and then store the formatted observations in a database or message bus. The system further includes an index component that retrieves observations from a database or message bus, organizes the observations according to temporal attributes, spatial attributes, metadata attributes or other similar attributes, tokenizes the text of the observations to allow for faster and more efficient storage and querying, and finally stores the organized, tokenized observations in an index. A query service component then accesses an index or plurality of indexes to enable execution of queries related to search terms in observations based upon certain query parameters. A client service component assimilates query results and generates query responses in the form of dynamic data feeds, interactive charts and graphs, lists, and other display media.

According to one aspect, an index component normalizes and associates the spatial, temporal, and metadata attributes of the observation into predefined time slots, spatial parameters, and metadata identifiers. The index component tokenizes any text contained within the observation, and associates the tokenized text with the normalized observation features within an index. In one aspect, each index is a memory-based index maintained in RAM. According to another aspect, each index is a persistence index maintained in a separate database.

According to an additional aspect, a query service component receives a particular query request from a user. The query service component parses the query request to identify particular search expressions and query attributes contained within the request. The query service component then executes the query request against any normalized and organized observations maintained within an index, and tracks occurrences of search terms or expressions, whether or not related to TOPIC TICKER™ symbols, and then reports occurrences of the search terms and expressions. In one aspect, the query attributes include start and end timestamp criteria for the particular query, an aggregation interval, one or more sources upon which to query, or any other query-related information.

In another aspect, a TOPIC TICKER™ symbol represents a particular query expression or group of query expressions associated with a specific subject matter or topic. In one aspect, the TOPIC TICKER™ symbol expressions include boolean commands and nested TOPIC TICKER™ symbol(s).

According to yet another aspect, the client service component analyzes the results of any search terms identified by the query service component and delivers an output containing statistical analyses of occurrences of the search terms as a function of user-defined parameters.

According to another embodiment, the present invention is directed towards a method for performing semantic analysis on observation data. The method includes the step of collecting observations emitted from a plurality of sources. Once collected, the method also includes the steps of processing the observations to transform the observation attributes from source-specific formats into a general system format, and then storing the formatted observations in a database or message bus. The method further includes the steps of retrieving observations from a database or message bus, organizing the observations according to temporal attributes, spatial attributes, metadata attributes or other similar attributes, tokenizing the text of the observations to allow for faster and more efficient storage and querying, and finally indexing the organized, tokenized observations. Next, the organized, tokenized observations are accessed to enable execution of queries related to search terms in observations based upon certain query parameters. The method also includes the steps of assimilating query results and generating query responses in the form of dynamic data feeds, interactive charts and graphs, lists, and other display media.

According to one aspect, the indexing step further includes normalizing and associating the spatial, temporal, and metadata attributes of the observation into predefined time slots, spatial parameters, and metadata identifiers. Additionally, the indexing step includes tokenizing any text contained within the observation and associating the tokenized text with the normalized observation features.

According to an additional aspect, the method further includes the step of receiving a particular query request from a user. The query service request is parsed to identify particular search expressions and query attributes contained within the request. The method further includes the steps of executing the query request against any normalized, indexed observations, and tracking occurrences of search terms or expressions, whether or not related to TOPIC TICKER™ symbols, and then reporting occurrences of the search terms and expressions. In one aspect, the query attributes include start and end timestamp criteria for the particular query, an aggregation interval, one or more sources upon which to query, or any other query-related information.

According to another aspect, the method also includes the step of analyzing the results of any search terms identified in the normalized, indexed observations and delivering an output containing statistical analyses of occurrences of the search terms as a function of user-defined parameters.

These and other embodiments and aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a high-level overview of an embodiment of the present invention.

FIG. 2 is a chart illustrating occurrences of sample search expressions across a plurality of sources according to an embodiment of the present invention.

FIG. 3 is a flow chart illustrating the logical system architecture according to an embodiment of the present invention.

FIG. 4A is a flow chart depicting the operations of a data ingest component specific to an observation file according to an embodiment of the present invention.

FIG. 4B is a flow chart depicting the operations of a data ingest component specific to an observation stream according to an embodiment of the present invention.

FIG. 5 is a flow chart illustrating the functions of an index component in an embodiment of the present invention.

FIG. 6 is a flow chart demonstrating the operations of a query service component according to an embodiment of the present invention.

FIG. 7 is a flow chart showing the functions of a client service component for delivering a data feed to a user in an embodiment of the present invention.

FIG. 8 is screen shot of a sample data structure containing various TOPIC TICKER™ symbols and related search expressions according to an embodiment of the present invention.

FIG. 9 is a screen shot of a sample data feed output in an embodiment of the present invention.

FIG. 10 is a screen shot of a spreadsheet output to a user based on a data feed according to an embodiment of the present invention.

FIG. 11A is a screen shot of a sample query interface in an embodiment of the present invention.

FIG. 11B is a screen shot of an interface demonstrating occurrences of search expressions on a per source basis corresponding to outputs shown in FIG. 11A according to an embodiment of the present invention.

FIG. 11C is a screen shot of individual observations corresponding to the sources displayed in FIG. 11B.

FIG. 12A is a screen shot of a sample geospatial view output according to an embodiment of the present invention.

FIG. 12B is a screen shot of a sample heat map output in an embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatuses, systems, and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

In general, embodiments of the present invention provide novel systems and methods for collecting, processing, analyzing, and indexing large amounts of data in such a manner that queries can be formulated and exercised against the data in an expedient manner. Embodiments of the present invention also provide for static or dynamic presentation of the indexed data based upon the queries. The data organization and access techniques applied in embodiments of the present invention are structured in a way that allows for a large variety of queries to be performed on the data without having to reorganize the data. Additionally, indexes and presentations of the data are continually updated and modified in virtually real-time.

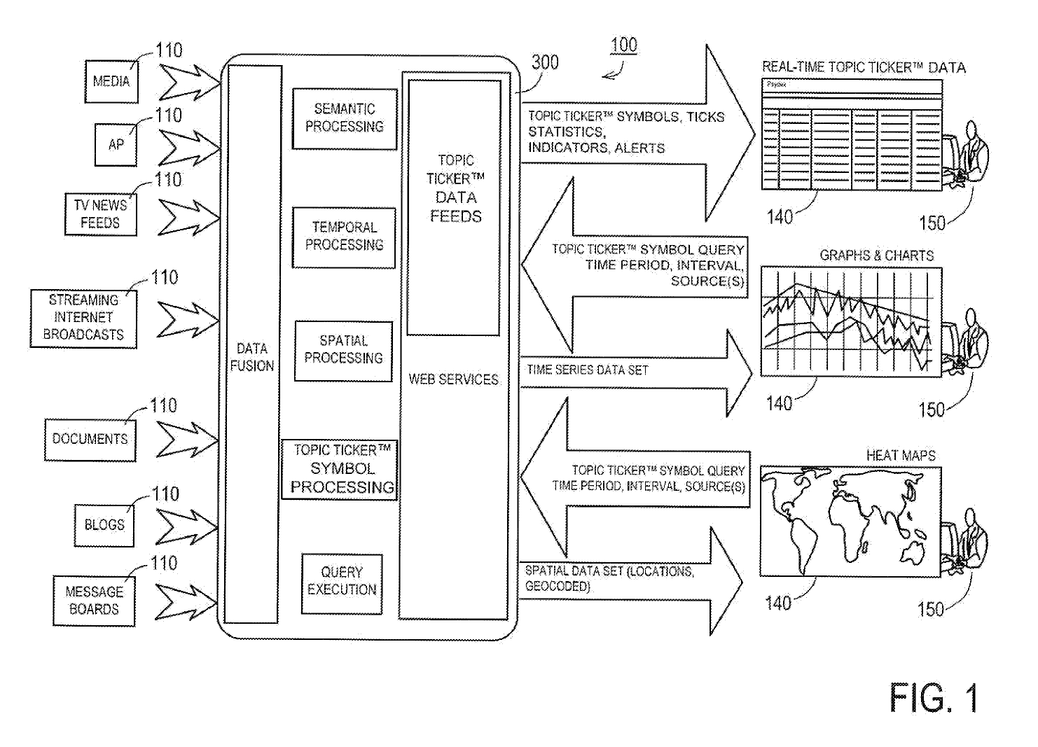

Referring now to the drawings, FIG. 1 illustrates a high-level overview of a system 100 according to one embodiment of the present invention. In the embodiment shown, a plurality of sources 110 emit data into the system 100, and specifically into the logical system architecture 300. The logical system architecture 300 processes and indexes the data based on temporal, spatial, and other parameters, and responds to queries based upon the data. The data is transformed and analyzed within the logical system architecture 300, and is finally transmitted to a client 150 in a presentable or usable format, such as a graph, list, chart or data feed, such as shown by outputs 140.

Preferably, the data emitted by the sources 110 and collected by the system architecture 300 is referred to as “observations.” Such observations typically include documents, streaming conversations, threaded discussions, online postings, and many other information delivery mechanisms. For example, a document may include a press release regarding a company merger or an article describing a CEO's fraudulent behaviors. A streaming discussion might be a breaking story delivered by a television news anchor or an online webcast about recent oil prices. A threaded discussion could comprise internet message board postings or a blog discussion about a presidential campaign. In one embodiment, the observations are text-based (for instance, a document). If the observations are not text-based upon initiation (for instance, a streaming news story), then they are converted to text via closed captioning, speech-to-text technology, or another similar methodology.

When an observation is received by the logical system architecture 300, it is assigned one or more attributes to enable the system 100 to track and identify the observation. These attributes may include, but are not limited to, the component within the system architecture 300 that observed the observation, where the information was observed from (the source 110), when it was observed (the moment in time or within a particular normalized, associated time period), and what was observed (the content). These attributes, and any others, may be assigned to any observation. In one embodiment, an attribute consists of an attribute name and value pair. Each source 110 may have a unique set of attributes, and these source-specific attributes are mapped to a set of reference attributes, for normalization purposes (discussed in greater detail below).

Embodiments of the present invention operate with a large variety of sources 110, and although some of the particular configurations that are provided in this description may be considered as aspects of the invention, or even inventive in and of themselves, the present invention, unless otherwise indicated in the claims, is not limited to any particular sources 110 or types of sources 110. Non-limiting examples of source types that may be employed in or utilized by various embodiments of the invention include closed caption feeds, Really Simple Syndication (RSS) feeds, blog(s), Associated Press® feeds, Reuters® feeds, and other press feeds, etc.

More specifically, closed caption feeds may include national based feeds such as financial information from CNBC and Bloomberg, news from FOX NEWS, MSNBC, CNN, and CNN HEADLINE NEWS, documentaries from C-SPAN, C-SPAN2, and the HISTORY CHANNEL, weather reports from THE WEATHER CHANNEL, and other similar feeds. The closed caption feeds may also include local and regional feeds such as ABC, CBS, NBC and PBS from various cities or regions.

The RSS feeds may be of any variety of RSS channels and may include public, well known feeds such as GOOGLE NEWS and MOREOVER, as well as other more specific, smaller and focused feeds. Similarly, the blogs may include content from blog search engines such as GOOGLE and TECHNORATI, as well as other more specific, smaller and focused feeds.

Sources 110 may be organized in a hierarchical taxonomy around communities of interests or themes. In essence, any device or system that provides information content that can be digitized or converted into textual content or streams can serve as a source 110. For instance, lectures, radio or broadcast content, telephone conversations, etc. can all be converted into text and serve as sources 110. In addition, sources 110 can provide any observations that are already in a textual form, such as web sites, emails, ticker tapes, teletype feeds, etc. Likewise, other content that can be converted to text through optical character recognition (OCR) can also be included as a source. Thus, it will be appreciated that embodiments of the present invention can work with virtually an unlimited list of sources 110 to ingest a virtually unlimited number of observations.

In various embodiments of the present invention, the sources 110 may be selected based on the particular application for the system 100. For instance, if the system 100 is being used by financial market traders to predict or track stock trends, the sources 110 may include financial and business related feeds. If the system 100 is being used to predict violence in American high schools, the sources 110 may include web sites and blog(s) that are frequented by high school students, as well as other sources typically viewed by high school students. Similarly, sources 110 can be configured to focus on specific areas such as hot political topics, up and coming politicians, sports, financial trends, national defense issues, etc.

Additionally, the sources 110 for a particular embodiment of the system 100 may be event driven. For instance, if a particular trend is detected, the pool of sources may be dynamically changed in response to the trend or event. As an example, assume an embodiment of the system 100 is configured to watch world events. Such a system would most typically utilize a variety of sources 110 from a variety of countries in an effort to obtain the widest spectrum of views and biases. If a nuclear test is performed in India, for example, the sources for such a system may then be augmented with sources that are connected with India and its neighboring countries. Likewise, if a pandemic breaks out, the sources may be augmented to focus on areas of the outbreak as well as related feeds and news sources.

Furthermore, according to some embodiments, sources 110 may be weighted or prioritized for individual users or communities of users. As an example, one user may consider CNN to be the most important source 110 as it pertains to his or her interests, whereas another user may feel that CNN is less relevant. Accordingly, each user can customize the importance of each source 110 within an embodiment of the system 100 by assigning weighted point values to each source. Thus, when a subsequent output 140 is received by a client 150 or user, that output data will reflect associated source weightings and relevance levels.

Once an observation is received from a source 110 by the logical system architecture 300, the observation is ingested, processed, and indexed according to given parameters (as described in detail below). The processed and indexed observations are stored within the logical system architecture 300, and occurrences of certain elements contained within the observations, as well as calculations derived data, statistics, and any other data relating to the elements and observations, are available for manipulation and delivery to a client 150 through various outputs 140 (also described in detail below). The client 150 may be an investment banker or stock trader, a government agency, a corporation, an individual, an organization, or virtually anyone that would be interested in accumulating or analyzing source data over time, or in a highly-efficient, virtually real-time manner.

In one embodiment, elements from an observation are extracted and assimilated to aid in prediction of market trends. For example, if an interested client 150 is a stock market trader or financial analyst, the client 150 may be interested in monitoring what news stories or items of discussion are happening across various sources 110 in the world in real-time. For instance, based on historical data, assume that a certain stock or commodity, say oil, generally rises and falls correspondingly as it is discussed in higher or lower volume across the media. For example, assume when crude oil or issues relating to crude oil are discussed in the news or across various sources 110 in higher than usual volume, the value of oil commodities rises. Alternatively, when oil is discussed with less frequency, the value falls. Thus, the client 150 may find it invaluable to know when there are peaks and/or valleys in discussions about oil across a plurality of pertinent sources 110. If the client 150 can be alerted to a spike in discussions about oil across varying sources 110 as the spike occurs in real-time, the client 150 may be able to buy or sell the commodity or stock accordingly to take advantage of an anticipated rise or fall in the price of the commodity or stock before the news trickles down to other investors or traders.

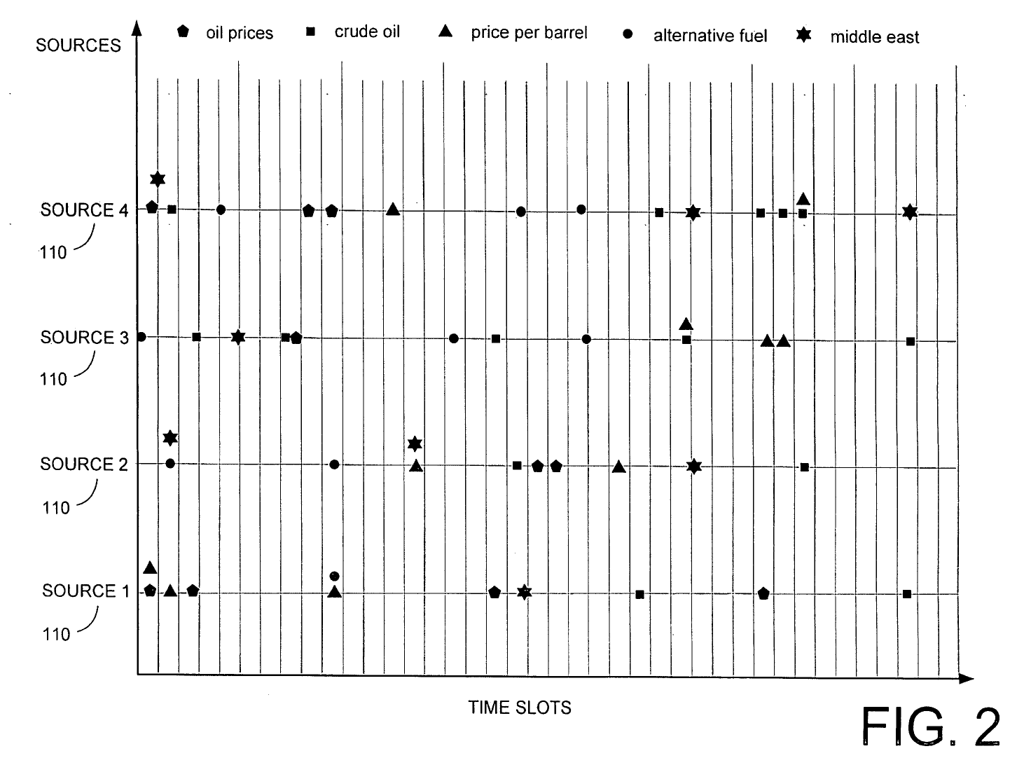

FIG. 2 is a chart showing the occurrence of five sample search terms for four sources 110 across a sample period of time according to another embodiment of the present invention. The chart represents occurrences of search terms defined by a particular client 150 across a given time period. In the embodiment, assume that an investor or trader client 150 is interested in buying or selling an oil commodity, and thus wants to know when terms related to oil are discussed by media outlets throughout the world. Accordingly, the client 150 has incorporated four sources 110 he or she believes are pertinent to or likely to discuss oil related issues. The client 150 has also defined five search terms lie or she believes will be stated or written if oil or oil commodities are being discussed. These search terms may or may not be related to a TOPIC TICKER™ symbol used for querying (discussed in greater detail below). The search terms specifically used in the example shown in FIG. 2 are “oil prices”, “crude oil”, “price per barrel”, “alternative fuel”, and “middle east”. Further, while only four sources 110 and a limited number of search terms are shown in FIG. 2, it should be apparent to one having ordinary skill in the art that many additional sources 110 and search terms are possible within embodiments of the present invention. Further, as will be described below, embodiments of the present invention allow for the dynamic generation or suggestion of semantically related concepts, search terms, or clusters of terms.

As an observation from a source 110 is ingested into the system 100, analyzed, and indexed, the system responds to a query from a client 150 and reports any occurrences of predefined search terms associated with that observation and source 110 according to any predefined parameters. The occurrence of a search term may be reported to the client 150 by simply alerting the client of the occurrence, or assimilating it in a chart with other occurrences, terms, and sources, or by further analyzing the occurrence and generating outputs 140 such as graphs, maps, lists, etc. For purposes of this disclosure, an occurrence of or reference to a search term, whether or not associated with a TOPIC TICKER™ query, is referenced as a “tick”. FIG. 2 shows the ticks associated with the sample search terms described above with geometric symbols. When a particular term is contained within a particular source 110 as time progresses, the system 100 reports the tick. Thus, for example, if source 3 is a streaming news telecast, it appears that the term “alternative fuel” was referenced during the telecast at the beginning of the time period being measured in this example. Additionally, time (plotted on the horizontal axis) may be normalized and associated into time slots (as shown in FIG. 2) to allow for faster and more efficient indexing and querying (discussed in greater detail below).

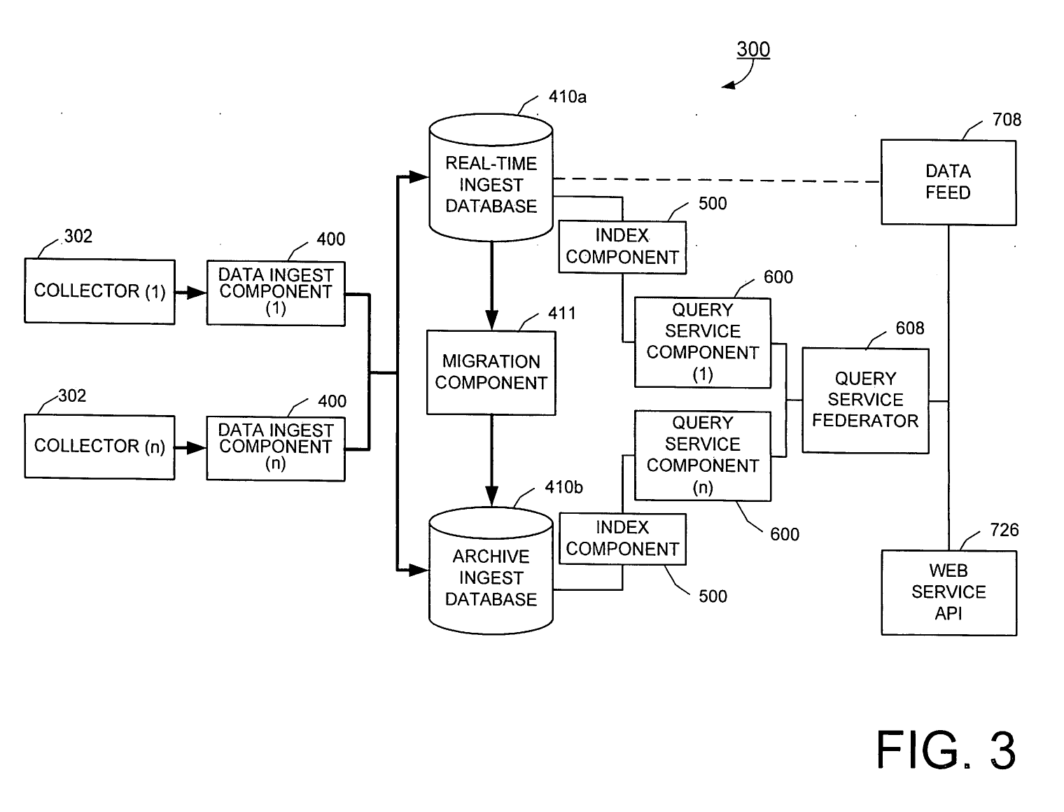

FIG. 3 represents an overview of the logical system architecture 300 according to one embodiment of the present invention. In general, the illustrated embodiment includes collectors 302, data ingest components 400, a real-time ingest database 410a and an archive ingest database 410b, a migration component 411, index components 500, query service components 600, a query service federator 608, a resulting data feed 708, and web service API 726. It should be appreciated by one of skill in the art that the delineation described for the components in FIG. 3 is conceptual, and although the particular breakdown and configuration may in and of itself be considered novel, the present invention is not limited to these conceptual categories. In fact, in some embodiments, aspects described in one component or function may be performed within another component or may be eliminated altogether and the functions performed in that component redistributed to other components.

The collectors 302 contain components and functions associated with gathering observations from sources 110. It will be appreciated that the present invention can be embodied in an environment that includes only one collector or any number of collectors. Collectors 302 employ interfaces native to a source 110 to collect observations and content in a virtually real-time fashion. To accomplish this, collectors 302 encapsulate source-specific logic and Application Programming Interface (API) calls. Accordingly, each collector 302 represents an instance of a particular collector type, which is a function of the characteristics of the source 110 feeding a particular collector 302. For example, different types of sources 110 may require different types of collection processes to be performed on each type of source. Thus, different collectors 302 are typically used for different sources 110. However, it should be appreciated that in some embodiments, a single collector can handle one or more sources and that multiple collectors may be used on a single source.

Within one embodiment, the collectors 302 may include software components, such as Blog Crawlers, Message Board Crawlers, Caption Decoders, etc., and/or hardware components, such as television Caption Recovery Decoders, servers, and other hardware systems. Additionally, some sources 110 may provide information and observations directly to the collectors 302, in which case File Transfer Protocol (FTP) servers, Network News Transfer Protocol (NNTP) servers, Secure Copy Protocol (SCP), and other conventional and proprietary transfer protocols may be used to collect the observations and transfer them to the data ingest component 400. In some embodiments, collectors 302 are distributed geographically and broadcast information back to proxy components deployed in a central location within the logical system architecture 300, such as a data center.

Once a collector 302 has collected an observation, it feeds the observation to the data ingest component 400. The data ingest component 400 contains functions and components associated with processing and organizing source-specific observations and information and then storing them in a database 410a, 410b for further processing. For some sources 110, the collector and data ingest component are merged into a single, streamlined component flow, such as in the case of a specifically configured blog Crawler or Message Board Crawler. Other sources require the performance of discrete collector functions before the observation is transferred to the data ingest component. In one embodiment, in addition to being stored in a database after initial processing, the observations are transmitted to end users via a message bus. It will be appreciated that the data ingest component 400 can take on a variety of features and operations and that embodiments of the present invention are not limited to any particular subset of such features. Additionally, it will also be appreciated that embodiments of the system 100 may include one data ingest component 400 or many data ingest components 400.

In some embodiments of the present invention, after initial processing in the data ingest component 400, observations are transferred to a database, such as the real-time ingest database 410a or the archive ingest database 410b, shown in FIG. 3. In the preferred embodiment, observations are initially transferred to the real-time ingest database 410a for more immediate processing. It will be appreciated to one having ordinary skill in the art that while only two databases are shown in FIG. 3, many more databases are possible within embodiments of the present invention. When multiple databases are used, the databases can be distributed or co-located. The databases can be organized in a variety of manners, and although one or more of the manners presented herein may be considered novel, embodiments of the present invention are not necessarily limited to any particular database schema.

In one embodiment, the real-time ingest database 410a receives the observations after they are processed by the data ingest components 400. This database 410a generally has the characteristics of an Online Transaction Processing (OLTP) database, which allows for multiple, concurrent read and write operations. This database 410a acts as a temporary repository for processed observations before the observations are accessed by the index component 500 or the data feed 708. Over time, the observations are moved from the real-time ingest database 410a via the migration component 411 to the archive ingest database 410b. Accordingly, the real-time ingest database 410a tends to contain fewer observations as compared to the archive ingest database 410b as a result of migration.

The real-time ingest database 410a is configured, in one embodiment, to take advantage of clustering and other high availability features of an underlying database management system. This database requires fast response times because of the overall speed and efficiency involved in embodiments of the present invention. For example, in one embodiment, the data feed 708 and the index components 500 poll the real-time ingest database 410a every 100 milliseconds for new observations. As will be understood, the real-time ingest database 410a may be polled at any interval the user or system operator desires. This rapid polling function enables embodiments of the present invention to produce outputs relating to new observations in a virtually real-time manner.

As mentioned, observations are moved from the real-time ingest database 410a to the archive ingest database 410b as a function of how long the particular observation or record has been in the real-time ingest database. For instance, a system operator could program the migration component 411 to transfer observations from the real-time database 410a to the archive database 410b every five minutes, or twenty minutes, or once a day, or once a week, or any other time period. In some embodiments, the archive ingest database 410b is configured like a data warehouse, such that the database 410b receives primarily read-only queries, and completes few or no writes. Configuring the database this way allows for fast and efficient retrieval of data without slowing down the operational systems of embodiments of the system 100. Generally, most archives or backups are created from the archive ingest database 410b, and on a recurring basis. As will be understood by one having skill in the art, while dividing the databases into real-time and archive databases increases efficiency and querying and decreases processing times, multiple databases are not required in embodiments of the present invention. For instance, the system 100 could use only one, large database to provide all of the needed read, write, and storage functions. Alternatively, as will also be understood, while only two databases are shown in FIG. 3, embodiments of the present invention may incorporate a plurality of databases or database schemas.

Still referring to FIG. 3, the index components 500 include data structures and algorithms used to execute query operations. For example, such query operations may include, but are not limited to, proximity, conjunction, disjunction, and negation queries. Generally, the index component 500 retrieves observations from a database (either the real-time ingest database 410a, the archive ingest database 410b, or another database), organizes and normalizes the observations according to temporal attributes, spatial attributes, metadata attributes, or other similar attributes, tokenizes the observations to allow for easier, faster and more efficient storage and querying, and finally stores the normalized, tokenized observations in an index. According to embodiments of the invention, the index may be a memory-based index that is maintained in Random Access Memory (RAM), a persistence index that is stored in a database, or some other similar type of index. In one embodiment, index components 500 may be plugged into or removed from the existing logical system architecture 300 to allow for customized operations or the introduction of additional or newer high-performance algorithms over time. Index components 500 may be allocated across a grid of query service components 600 to allow for the dynamic loading of index components 500 for updated functionality and for efficient distribution of workloads. Additionally, although only two index components 500 are illustrated in FIG. 3, it should be apparent to one having ordinary skill in the art that embodiments of the present invention may use only one index component, or, alternatively, may incorporate a virtually unlimited number of index components depending on the overall system 100 size.

Generally, the query service components 600 access the index components 500 to enable execution of queries related to search terms in observations based upon client-defined query parameters. In one embodiment, each query service component 600 corresponds to a particular source 110. In another embodiment, each query service component 600 may represent multiple sources 110, or, alternatively, one source may require many query service components. In an embodiment where one query service component 600 represents only one source 110, the query service component may operate in static mode, delivering a given snapshot of observations and query results for the particular source. The query service component may operate in dynamic mode, thus delivering up-to-date and dynamically changing content and observations beginning from a particular start date in the particular source 110.

In one embodiment, each query service component 600 is responsible for executing a query service request against a specific index within an index component 500. Thus, each query service component 600 has a one-to-one relationship with an index within an index component 500. In another embodiment, each query service component 600 may execute service requests against a plurality of indexes. In an embodiment where the query service component has a one-to-one relationship with an index within an index component 600, the query service component utilizes an index builder factory so that the query service component may declaratively (i.e. at run-time) instantiate a specific index.

Still referring to FIG. 3, the query service federator 608 maintains a pool of connections to one or more of the query service components 600. As will be understood by one of ordinary skill, although FIG. 3 shows only one query service federator 608, embodiments of the present invention may use a plurality of query service federators 608. The federator 608 is responsible for accepting query requests initiated from the client 150 and distributing or routing those requests or sub-sets of the requests to the appropriate query service components 600. The federator ensures execution by all appropriate query service components, fuses results from the query service components, and, when necessary or appropriate, performs operations that span the results of two or more query service components. As will be understood by one having ordinary skill in the art, embodiments of the present invention may be utilized without the query service federator 608, especially if only one query service component 600 is used. However, use of the federator 608 generally provides faster processing times and more efficient querying when a plurality of clients 150 and query service components are utilized because it centrally organizes and distributes query requests.

In one embodiment, the web service API 726 takes service requests from the client 150 and makes calls to the federator 608, and the data feed 708 requests data from the federator 608 for ultimate display to an end user or client 150. The data feed 708 and web service API 726 allow the client 150 to submit queries against a plurality of observations or sources 110 over varying time periods or in virtually real-time, view and analyze query responses, manipulate statistics and plot results in easily understandable formats, and complete many other tasks involving static or on-the-fly analysis and organization of observation content.

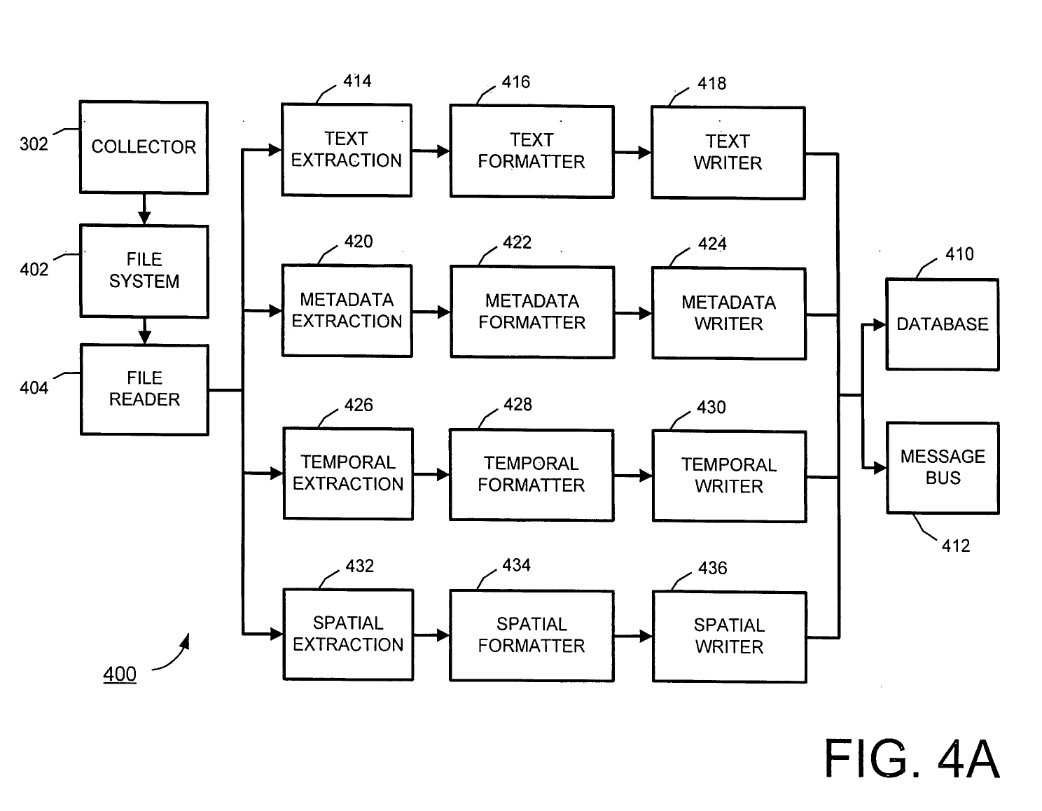

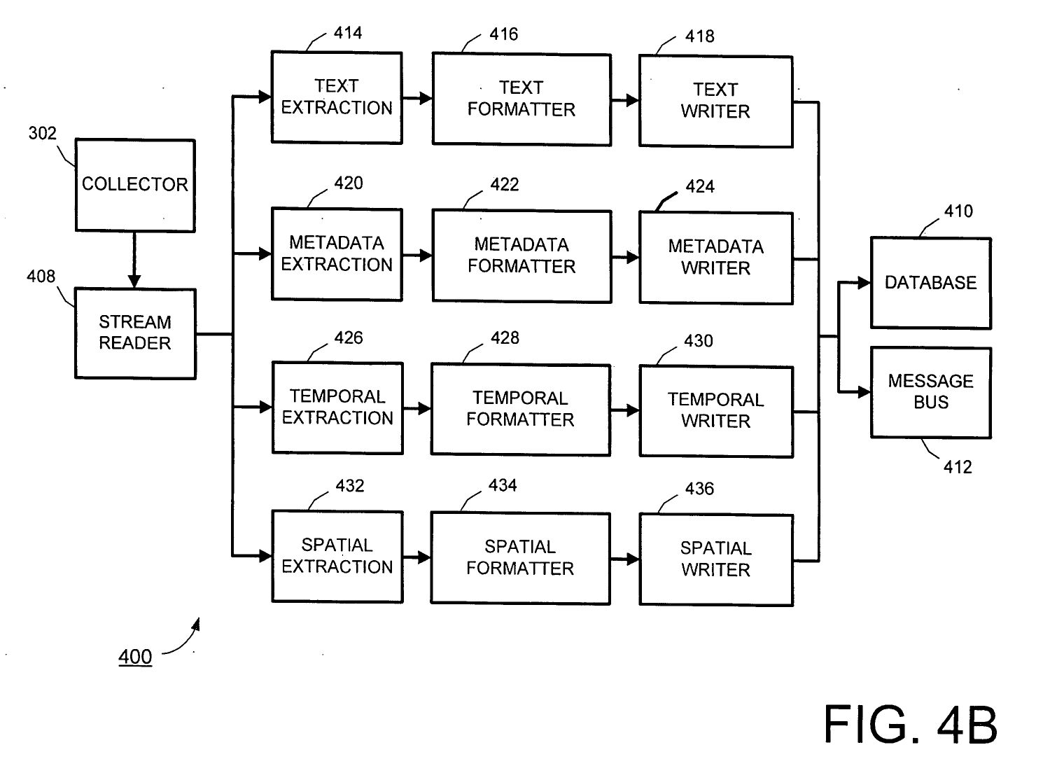

Referring now to FIGS. 4A and 4B, a flow chart depicting the operations of a data ingest component 400 is shown according to an embodiment of the present invention. As mentioned, once a collector 302 has collected an observation, it feeds the observation to a respective data ingest component 400, which contains functions and components associated with processing and organizing source-specific observations and information and then storing them in a database 410 or message bus 412 for further processing. In the embodiment shown, the database 410 refers to either the real-time ingest database 410a or the archive ingest database 410b. Generally, however, ingested observations will be sent to the real-time ingest database 410a to allow for frequent writes to the index component 500.

In the embodiment shown in FIG. 4A, once a collector 302 collects an observation, it feeds the observation to the file system 402 of a particular data ingest component 400. In this disclosure, a “file” refers to an observation with a discrete beginning and end. For instance, an article released by the Associate Press is released at a specific moment in time, and the article has a definite beginning and end. A file differs from a “stream”, which, for purposes of this disclosure, refers to an observation with no distinct beginning and end, such as a continuous closed caption television feed. If the observation is a file, it is fed to the file system 402, which is a shared system where files are stored and made available for the elements of the data ingest component 400 to read and process. Files may be saved to the file system 402 by various methods, including, but not limited to, FTP, NNTP, SCP, and other standard or proprietary transfer protocols. Generally, these files are received as a “push” form a content provider (such as the Associated Press), and are fed to the file system 402 via a collector 302.

The file reader component 404 loads one or more files from the file system 402 and makes the content (i.e. the text of the file and the file's attributes, such as when it was released) available for processing by other ingest components. In one embodiment, the file reader component 404 may operate in active or passive mode. In active mode, the file reader 404 polls the file system 402 on a regular interval, and loads files as they are persisted to the file system. In passive mode, the file reader 404 is run on demand or notified by an external control mechanism when it is time to read a file. Generally, file readers 404 are customized based on various file format standards of which a file may be formatted or encoded. For example, a file may be formatted via RSS, NEWSML (News Markup Language—an XML-based format designed to provide a media-independent, structural framework for multi-media news), or News Industry Text Format (NITF). The overarching purpose of the data ingest component 400 is to transform the file from a source-specific format into a source-neutral format suitable for indexing and further processing.

In the embodiment shown, the file reader component 404 uniquely identifies each file content with a specific content identifier. This content identifier is used by other parts of the data ingest component 400 to associate information with the original file. In one embodiment, the content identifier will include a unique key and database pointer. The combination of the unique key and database pointer will comprise the content identifier used to identify the file. For example, assume in an embodiment with a plurality of databases 410 that the file is ultimately stored in database “008”, and is given a unique key “93839”. Thus, the content identifier used to identify that particular file would be “database008:93839”. As will be understood by one of ordinary skill in the art, however, other identification mechanisms and/or pointers may be used to identify and reference particular file observations and content.

Referring to FIG. 4B, if the observation is a stream, the collector 302 delivers the observation to the stream reader component 408. Streams are generally defined by a specified protocol and byte/record format based upon the particular source 110 from which they were emitted, and thus the stream reader 408 reads the particular stream of bytes. For example, a source 110 may deliver an asynchronous stream of “packets,” such as for closed caption television, and the stream reader 408 will timestamp the individual packets such that the packets may be later assembled in an index component 500 data structure according to normalized time slots or frames. These timestamped stream packets are given unique content identifiers in a similar manner as file observations.

Referring now to both FIGS. 4A and 4B, after a file or stream has been assigned a unique content identifier, the file or stream is processed by the various parts of the data ingest component 400. The text extraction component 414 extracts text from a buffer of characters or bytes. The buffer represents the stream or file, and the text is the portion that is processed and indexed. A “buffer” refers to a region of memory used to temporarily hold data while it is being moved from one place to another. Thus, the text of the file or stream will generally be contained within a buffer when it is transferred from the sources 110 to the collectors 302. The extraction of text from the buffer is specific to the layout of the byte buffer (i.e. the file or stream format). In some embodiments, the text of the file or stream is formatted and is subsequently processed by the text formatter component 416 to remove presentation tags or elements. Accordingly, the text extraction component 414 requires knowledge of the specific character encoding of the file or stream to extract the text. For instance, the characters or bytes of a particular file or stream from a particular source 110 may be encoded in UTF-8 (8-bit UCS/Unicode Transformation Format) or some other character encoding format, and thus the text extraction component 414 requires knowledge of this format to extract the text from the buffer.

In one embodiment, the text formatter 416 converts the file or stream text from its original, formatted version into a version suitable for presentation, and into a raw text version suitable for indexing and further processing. For example, a source 110 may format the text of an observation with HTML (Hyper Text Markup Language) or store it in XML (Extensible Markup Language). In these cases, the text formatter 416 is necessary to convert the text from the source-specific formatted language into versions suitable for indexing and/or presentation and visualization. Additionally, in many cases, an HTML version of the text is available and provides formatting and “stylesheet” related tags. For indexing purposes, the HTML tags are removed, resulting in a raw form of the text, which is used for indexing and querying. In other cases, multiple parts are combined to form the text, for example, combining an observation's headline with its content body.

Once the stream or file has been formatted by the text formatter 416, the text is written by the text writer 418 to an output, such as a database 410 or message bus 412, and associated with the unique content identifier generated by the file reader 404 or stream reader 408. Generally, the text is stored in both its original form with presentation and formatting information (if available) and in a raw text form that is more suitable for indexing. As shown in FIG. 3, some embodiments stream formatted text to the data feed 708 without indexing or organizing the related file or stream.

Referring to FIGS. 4A and 4B, in one embodiment, the stream or file is also processed by a metadata extraction component 420 after the stream or file has been processed by the file reader 404 or stream reader 408 to extract any metadata from the buffer of characters or bytes. Metadata generally refers to structured, encoded data that describe characteristics of information-bearing entities to aid in the identification, discovery, assessment, and management of the described entities. Essentially, metadata contains information about data. Similarly to the text extraction component 414, the metadata extraction component 420 removes metadata from the buffer of the file or stream to transform the file or stream into a more suitable format for indexing. With regards to metadata attributes for a specific stream or file, these attributes may include the headline or title of the file or stream, the subject, the category, the author, the publish date, or any number of other attributes. Essentially, metadata includes any name-value pair that adds additional meaning to the content or observation.

One embodiment of the present invention includes multiple variations of the metadata extraction component 420, each of which is tailored for a specific format, structure, or source 110. For example, NEWSML has a rigorous specification that outlines required and optional attributes that are to be associated with a valid NEWSML document. Thus, a NEWSML-specific metadata extraction component 420 can be used when a NEWSML byte buffer is detected, and specific attributes and their associated values may be successfully extracted from the buffer. Another source 110 may tag the underlying data with an XBRL (Extensible Business Reporting Language) taxonomy, and thus a specific metadata extraction component 420 should be formatted for XBRL buffers. Other sources 110, such as RSS feeds, NITF feeds, and many others, all require source-specific metadata extractors 420. Additionally, it will be understood to one having ordinary skill in the art that some sources 110 may not encode the streams or files with metadata, and thus the metadata extraction component 420 will not be required for those sources 110.

After metadata has been extracted from the file or stream, the metadata formatter 422 maps source-specific attribute names to a consistent map. Often, even when formatting standards are used by a particular source 110 or content provider, there exists ambiguity in a format specification, or the source or content provider deviates from its declared standards, thus leading to inconsistencies in metadata. Additionally, when proprietary content is provided, there may be no associated formatting standards available. Further, certain values may comprise different forms, as is often the case when representing “timestamps” (i.e. when the specific file or stream was released by the source 110). For example, one source 110 may define the “headline” attribute to be 20 characters in length, whereas another source or content provider may define this attribute to be 50 characters in length. The metadata formatter 422 maps these source-specific attributes to a consistent map, thus normalizing the attributes for more efficient later processing and indexing.

The metadata writer 424 associates the metadata attribute names and values with the unique content identifier generated by the file reader 404 or stream reader 408, and writes those associated attribute names and values to a database 410 or message bus 412. As an example, assume that the file discussed above with the unique content identifier of “database008:93839” was written by John Q. Publisher. Accordingly, a sample record for that file created by the metadata writer 424 could be: content identifier=database008:93839; metadata attribute name=author; metadata attribute value=John Q. Publisher.

Additionally, in some embodiments of the present invention, a temporal extraction component 426 is utilized to extract temporal attributes from the buffer of characters or bytes. An example of a temporal attribute could be the timestamp of when the observation was published or released from the source 110. Within the particular stream or file, the temporal attributes may be either explicitly defined as metadata, or may be implied by a timestamp in the text, or may be assumed based on when the buffer became available (for example, when the file was written to the file system 402). In one embodiment, temporal attributes are extracted along with other metadata via the metadata extraction component 420. In other embodiments, however, temporal attributes are treated separately from other metadata attributes to enable the content of the file or stream to be normalized according to time. As will be described in greater detail below, normalization and association with a particular “time slot” in some embodiments of the invention allows for unique indexing and querying of the content of the files and streams.

Once the temporal attributes have been extracted from the buffer of the particular file or stream, the temporal formatter 428 normalizes the source-specific time zone and format information to a consistent time zone and date/time format. For example, an embodiment of the present invention may ingest observations from sources 110 located in many different time zones across the world. Thus, in order to normalize the timestamp of the particular stream or file and compare it to other streams or files released across varying time zones, the specific timestamp is converted to a standard time zone (for instance, the eastern time zone in the U.S.). Additionally, different sources 110 may use different time formats to represent observation release times. For instance, to represent the time 9:08:07 PM on the date Feb. 27, 2008, one source 110 may use a format of 02/27/2008 09:08:07 PM EST, while another source 110 may use a format of 2008/02/27 21:08:07 EST. Thus, these times and dates are converted to a standard, normalized format (for example, the eastern U.S. time zone with format mm/dd/yyyy hh:mm:ss Z). As will be understood, any format or time zone may be used to normalize the temporal attributes of the observations as long as it is consistent across all observations. By using a consistent, normalized time zone and data format, querying of the temporal attributes will not require any assumptions to be made about the attributes themselves. Thus, a consistent time zone and date format enables concurrent processing of observation content across a plurality of time zones from a plurality of sources 110.

The temporal writer 430, much like the metadata writer 424, associates the temporal attributes and values with the unique content identifier for the particular stream or file, and writes those associated attribute names and values to a database 410 or message bus 412. A sample record generated by the temporal writer 430 may be, for example: content identifier=database008:93839; temporal attribute name=publish timestamp; temporal attribute value=02/27/2008 21:08:07 EST.

Still referring to FIGS. 4A and 4B, in some embodiments of the present invention, a spatial extraction component 432 may be utilized to parse explicit attributes from observation metadata, or to extract from the text of the file or stream specific features such as places, locations, addresses, geospatial coordinates, cities, states, provinces, countries, etc. These spatial attributes or features may be extracted from the text of the stream or file itself to analyze specific locations discussed within the observation, or from metadata to determine the location from which the particular observation was emitted (e.g. the story was written and published in Paris, France). In some embodiments, “gazetteers” or regular expression parsers may be utilized within the spatial extraction component 432 to identify and extract particular locations.

After spatial information has been extracted from the file or stream, the spatial formatter 434 formats that information into a consistent model or form. The overall purpose of the spatial formatter 434 is similar to that of the other formatters within the data ingest component 400, namely, to normalize the information and convert it into a standard format suitable for indexing and further processing. As an example, one source 110 may publish observations with geospatial coordinates in a “degrees, minutes, seconds” format, while another source 110 may publish observations in decimal degrees format. These varying observations are normalized by the spatial formatter 434 into one, consistent format (decimal degree coordinates, for example) to allow consistent indexing of a plurality of observations across the spatial dimension. Ultimately, identification of spatial information enables embodiments of the present invention to analyze the information and present “heat maps”, geospatial views, and other presentation views demonstrating areas of the world that may discuss certain topics or terms in higher frequency than other areas across given time periods.

Once the spatial information has been formatted, the spatial writer 436, much like the temporal writer 430 and metadata writer 424, associates the spatial attributes and values with the unique content identifier for the particular stream or file, and writes those associated attribute names and values to a database 410 or message bus 412. A sample record generated by the spatial writer 430 may be, for example: content identifier=database008:93839; spatial attribute name=referenced country; spatial attribute value=Iraq.

As discussed, in one embodiment of the present invention, the formatted stream or file is written from the data ingest component 400 to a database 410. The database 410 could be either a real-time ingest database 410a, or an archive ingest database 410b, or some other type of database. Generally, the database 410 is a shared persistence with source-specific schemas capable of storing all aspects of the collected and ingested observations and content, including, but not limited to, the raw text, formatted text, and attributes such as the headline or title of the file or stream, the publish timestamp and other temporal data, spatial information, and other metadata attributes. As discussed, each content record generated by the data ingest component 400 may be retrieved via a unique content identifier assigned to each observation and associated record. In one embodiment, all attributes are indexed within the database 410 in such a way that content may be retrieved with specific search criteria.

In another embodiment of the present invention, ingested and formatted files or streams may be written to a message bus 412 for further delivery to additional software components or elements of the overall system 100 rather than being directly written to a database 410. The message bus 412 is essentially a channel to push the observations to listening or interested software components. For example, a database writer could be implemented as a listener on the message bus 412, which would write observations to the database 410. Or, a real-time notification capability could be implemented that notifies users or clients 150 when content with particular text or metadata attributes that match a given search criteria is collected and ingested. As will be appreciated by one of ordinary skill in the art, many workflows or software components may be implemented as “listeners” to the message bus 412. Additionally, the message bus 412 may be based on a publish-subscribe (pub-sub) model, queue model, or other similar model. Within embodiments of the present invention, a message bus 412 may be based on a standard specification such as a Java Message Service (JMS), which is an API for sending messages between two or more components, or some other commercial product such as TIBCO RENDEZVOUS.

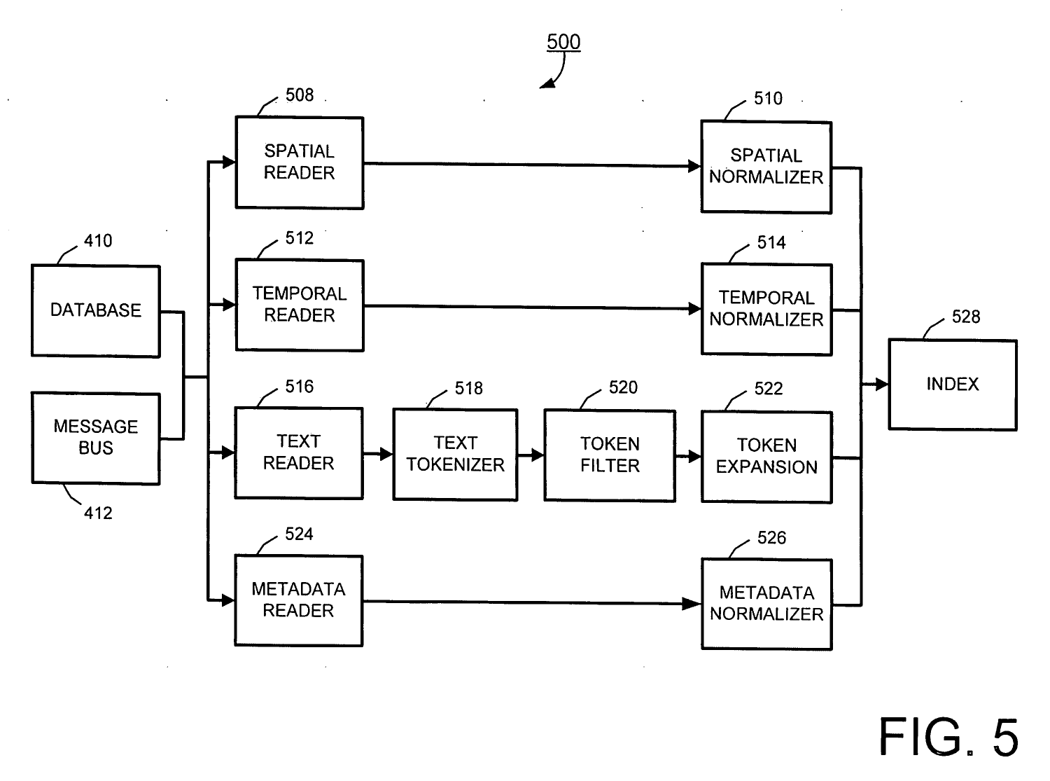

FIG. 5 is a flow chart illustrating an index component 500 according to an embodiment of the present invention. Generally, an index component 500 receives ingested files or streams from a database 410 or message bus 412, normalizes and organizes those files or streams according to various parameters, and executes query operations against those observations via algorithms and data structures. As shown in FIG. 5, the elements of an index component 500 correspond to the elements of a data ingest component 400 (i.e. spatial, temporal, metadata, and text). However, as will be understood by one having ordinary skill in the art, other configurations and elements are possible within embodiments of the present invention.

One of the elements of the embodiment of the index component 500 shown in FIG. 5 is the spatial reader 508. The spatial reader 508 reads spatial attributes of a file or stream from a database 410 or message bus 412 and transfers those attributes and corresponding files or streams to the spatial normalizer 510. The spatial normalizer 510 further normalizes the spatial attributes and values into predefined spatial parameters depending on the level of desired granularity. For example, one embodiment may require the ability to query and aggregate spatial information at ¼ mile scale. Support for this level of granularity would require collapsing ticks associated with certain observations into ⅛ mile grids. Accordingly, this level of granularity would support search results within ¼ mile, but with ⅛ mile precision. Further, different spatial models, such as a geographic coordinate system or decimal degree coordinates, may be used within embodiments of the present invention to normalize and associate spatial attributes.

Another element of the index component 500 shown in FIG. 5 is the temporal reader 512, which reads temporal attributes of a file or stream from a database 410 or message bus 412 and transfers those attributes and corresponding files or streams to the temporal normalizer 514. The temporal normalizer 514 creates “time slots” in which to group data or information. A time slot is a conceptual organizing principle (i.e. a virtual “bucket”) that supports grouping of information around a normalized instant in time (i.e. within a predefined time frame). The time slots allow tokenized text (discussed below) and other metadata to be grouped around certain time periods. Thus, each timestamp for each file or part of a stream is normalized and associated by the temporal normalizer 514 into a particular time slot. Additionally, multiple normalized time slots (i.e. dimensions) may be created to improve the overall performance (i.e. the time needed to aggregate) of information around these common time frames. These time slots or frames may be organized in any increments the user or system operator desires, such as 10 seconds, 1 minute, 1 hour, 1 day, 1 week, 1 year, etc. It should be appreciated, however, that more or fewer time periods could be utilized depending on the particular applications of the embodiment of the invention. Thus, time slots with smaller granularities, such as 1 second or fractions of a second, as well as larger granularities, such as 5 years, 10 years, etc. may also be used.

As an example, assume the temporal normalizer 514 is configured to normalize and associate tokens of information and other metadata into 10-second time slots. Also assume a particular file contains a timestamp of 01/01/2008 10:01:52.393. In this example, this timestamp may be normalized and associated into a time slot that begins at 01/01/2008 10:01:50.000, and ends at 01/01/2008 10:01:59.999. Additionally, all other tokens and information from files or streams observed during this time period are normalized and associated within this same time slot or frame. In this way, content and metadata from a plurality of sources 110 across a plurality of time zones with a plurality of different attributes may be normalized and categorized into particular time slots according to one temporal organizational schema.

Furthermore, normalization and association according to time slots enhances query performance and allows for more efficient searching. For example, the temporal normalizer 514 may be configured to arrange data into 10-second or 1-hour time slots as a function of the storage availability and desired performance of the particular embodiment. The benefits of temporal organization are fully realized when a user or client 150 wishes to search for particular search terms across many sources 110 over an extended period of time. Say, for example, a client 150 wishes to query for the word “MICROSOFT” and “Bill Gates” within 10-second intervals in a packet or stream or within the same document across a variety of sources 110 over the past 5 years. Also, assume the client 150 wishes to organize the results in hourly buckets. This temporal slotting allows for easy and efficient temporal proximity queries across large time spans and quick organization of the aggregated results.

In addition to the temporal and spatial components of the index component 500, a text component is also contained within the embodiment shown in FIG. 5. The text component is where tokenization of text from observation files or streams occurs. The text reader 516 reads text bytes from a database 410 or message bus 412. Depending on the particular embodiment, the text reader 516 may need to detect character encoding (such as UTF-8), particular languages (e.g. English-US, English-UK, French, Spanish, etc.), and any other text attributes that make it possible to perform other text-related functions, such as tokenization. “Lexical analysis” is the process of converting a sequence of characters into a sequence of tokens. A token is a categorized block of text. The block of text corresponding to the token is often referred to as a “lexeme.” A lexical analyzer processes lexemes to categorize them according to function, giving them meaning. This assignment of meaning is known as “tokenization.” Overall, tokenizing the text of the observations allows for more efficient storage and faster querying of the content associated with the tokens. This tokenization process occurs over the course of the components shown in the embodiment of FIG. 5, namely, the text reader 516, text tokenizer 518, token filter 520, and token expansion component 522.

More particularly, in one embodiment the text tokenizer 518 receives a file or stream buffer from the text reader 516, and splits the buffer using white-space delimiters (e.g. spaces, punctuation, etc.). In one embodiment, this tokenization feature is customizable for each individual language where delimiters can change. For example, German sources 110 may publish observations with different types of delimiters as compared to French sources 110 and observations. The output of the text tokenizer 518 is a set of individual tokens, such as words, letters, numbers, etc. These individual tokens are passed to the token filter 520, which removes certain letters or numbers from the set of tokens. These filtered words or numbers are referred to as “stop” words. Stop words are words or numbers that are of no interest or do not convey relevant, significant, or desired information. It should be appreciated that the stop words may vary depending on the particular application or embodiment. For instance, in an application focusing on the collection and analysis of political or athletic information, the words “the” and “and” may be filtered out as a stop words. However, in an application analyzing the stock market, these words would not be filtered out as they may represent ticker symbols for companies traded on the New York Stock Exchange (NYSE).

Similar to having different sets of stop words for various applications, embodiments of the present invention may also use different stop words selected on a source 110 by source 110 basis. For instance, content coming from a blog may have a different set of stop words than RSS content. Likewise, content received from CNN may have a different set of stop words than an AP article. Within some embodiments, stop words may also be selected on a user by user basis.

After the tokens have been filtered by the token filter 520 to remove stop words, the tokens are modified by the token expansion component 522 to expand upon the particular token. For example, a given word may include synonyms to which the token may be expanded. In one embodiment, the token expansion component 522 includes a stemming function to map a particular word to its root form for better organization and querying. After the text has been tokenized, it is transferred to the index 528 for available processing and querying. The tokenized text is associated in the index 528 with its time slot and spatial attributes generated by the temporal normalizer 514 and spatial normalizer 510, respectively.

Another element within the index component 500 is the metadata reader 524, which reads metadata attributes (name-value pairs) from a database 410 or message bus 412 and passes the attributes to the metadata normalizer 526 for further normalization. This normalization provides for consistency amongst metadata attribute names and values. For example, one source 110 may call a “headline” a “subject,” whereas another source 110 may call the “subject” a “headline.” In this example, “headline” could be the normalized name and both metadata attributes are mapped to the canonical name “headline.” In another example, sources 110 may create subject or category codes that have direct overlap or are very similar to each other, but without a reference taxonomy it is difficult to query against these sources 110 efficiently. Thus, within embodiments of the present invention the metadata normalizer 526 can be configured with source-to-reference taxonomies for metadata attribute names and values.

Once normalized and associated, all file or stream text and attributes are associated and stored within an index 528 for further analysis and querying. In one embodiment, the index 528 is a memory-based index, wherein the index 528 is maintained in RAM (Random Access Memory). The use of this memory-based index allows for extremely fast processing times and efficient querying. In another embodiment, the index 528 is a persisted index, wherein the index 528 is maintained in a database. The persisted index is generally slower in terms of read and write operations, but it typically has a larger capacity as compared to a memory-based index. As an example, if a stock trader is utilizing an embodiment of the present invention to analyze the occurrence of specific terms across a plurality of sources 110 in virtually real-time, then the stock trader would likely use an embodiment containing memory-based indexes to allow for faster querying operations and virtually real-time results. On the other hand, if a company was interested in analyzing stock trends as compared to occurrences of certain terms in the media over a period of years, and not necessarily in terms of what is happening at that very moment, then a persisted index may be beneficial. Additionally, although only one index 528 is illustrated in FIG. 5, it should be understood by one having skill in the art that a plurality of indexes 528 may be implemented within embodiments of the present invention.

Further, it should be understood that indexing data according to the embodiments described above enables fast, efficient searching for search terms, groups of search terms, nested search terms, and TOPIC TICKER™ symbols (described below), within observations and content without having to re-index the content when new searches or search expressions are created. Because all incoming data and observations are normalized and stored in indexes 528, rather than defined and stored in databases, new search expressions or queries may be implemented against the normalized data without re-indexing all data. In this way, embodiments of the present invention separate knowledge or semantics (search expressions) from the raw, indexed data.

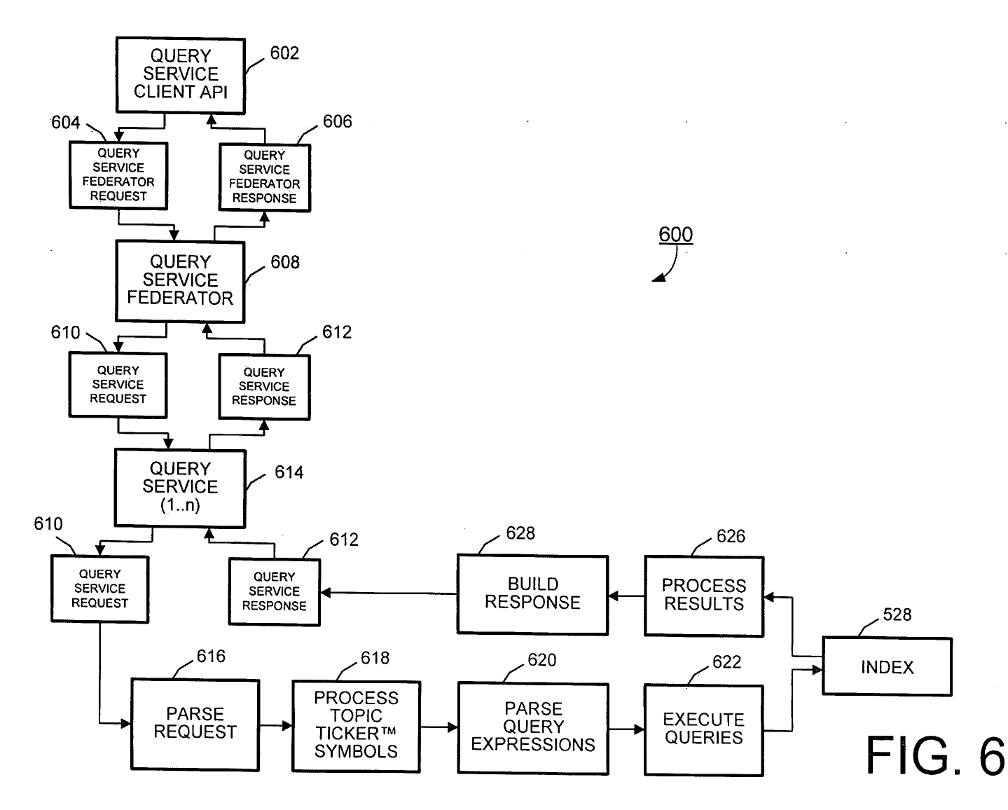

FIG. 6 is a flow chart illustrating a query service component 600 according to one embodiment of the present invention. Generally, each query service component 600 contains functions and components associated with retrieving content, such as text, metadata attributes, temporal attributes, spatial attributes, time series data sets, spatial data sets, statistics, and other information from an index component 500. Within the query service component 600 shown, the query service client API 602 is the delegate or component in the process space of a calling application or system. This component allows for connecting, disconnecting, and executing query requests. In one embodiment, the query service client API 602 is also responsible for establishing the connection to a web service and transmitting or serializing information between the web service and the client 150. In one embodiment, communications protocols such as TCP/IP (Transmission Control Protocol/Internet Protocol), UDP (User Datagram Protocol), or other similar protocols may be used as socket interfaces for the connection. By design, the query service client API 602 supports connecting to either a query service federator 608 or directly to a query service 614. Preferably, the query service client API 602 connects to the query service federator 608 because it supports access to a plurality of query services 614.

In one embodiment, the query service federator request 604 is a query initiated by a client 150. In one embodiment, the query service federator request 604 includes the request type (e.g. a time series summary, spatial detail, etc.), a query expression, start timestamp criteria, end timestamp criteria, and the aggregation interval (e.g. hourly, daily, weekly, etc.). Additionally, the request 604 may also include a list of inclusive sources 110 against which to query, as well as spatial and metadata attribute criteria. As will be understood by one having skill in the art, the query service federator request 604 may include virtually any information the user desires related to a particular query. As will also be understood, the query service federator request 604 may correspond to a discrete query initiated by a client 150, or a series of queries relating to a continuous delivery of information to a data feed or stream (discussed below). The query service federator 608 receives the query service federator request 604 and distributes the request to the appropriate query service 614. As mentioned previously, the query service federator 608 maintains a pool of connections to one or more query services 614, and ensures that all query service 614 operations are conducted appropriately.

The query service request 610 operates in the same way and has the same functions as the query service federator request 604, except that the query service request 610 is channeled from the query service federator rather than the query service client API 602. The query service 614 receives the query service request 610 (either from the federator 608 or directly from the client API 602), and executes that query request against a specific index 528 contained within an index component 500. In one embodiment, each query service 614 has a one-to-one relationship with an index 528. Additionally, as shown in FIG. 6, one embodiment may only have one query service 614, while other embodiments will have n query services 614 depending upon the number of indexes 528 contained within the embodiment.

Still referring to FIG. 6, the query service request 610 is furthered from the particular query service 614 to the parse request element 616 of the query service component 600. The parse request element 616 parses and interprets the request's attributes. If a request 610 is invalid for any reason, an exception to the request is chained back to the calling application (i.e. the query service client API 602). One embodiment of the present invention will support query requests 610 with simple or nested search expressions with keywords, phrases, lists of keywords and/or phrases (Boolean OR), proximity (Boolean AND), exclusion (Boolean NOT), and TOPIC TICKER™ symbols.

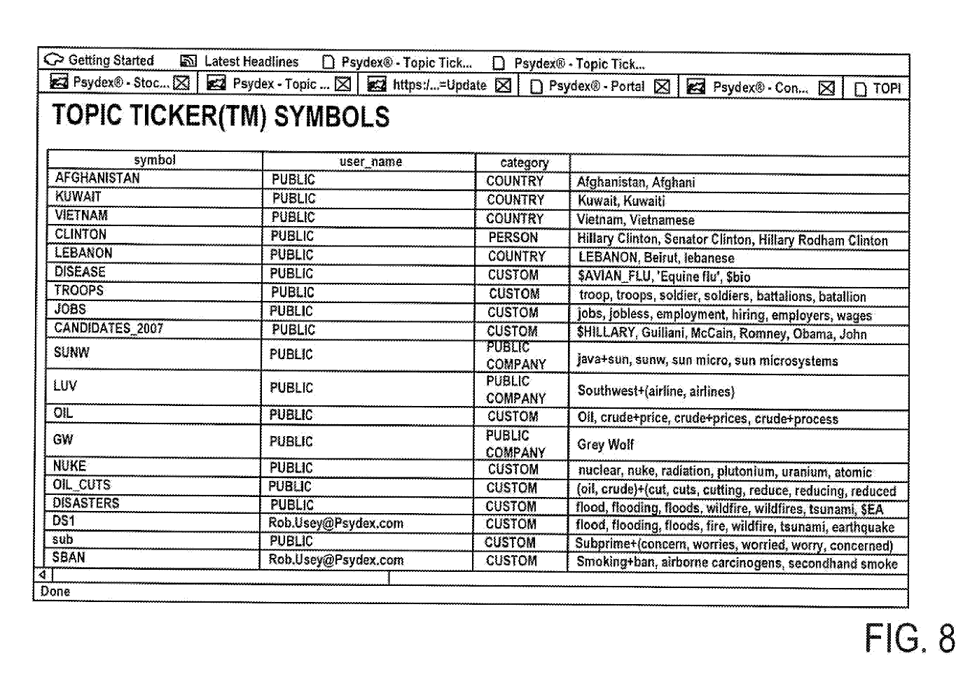

Once the request 610 has been parsed, if the request is based upon a TOPIC TICKER™ symbol, then that TOPIC TICKER™ symbol is processed 618. In one embodiment, each specific TOPIC TICKER™ symbol relates to a query expression associated with a specific subject matter or term. The TOPIC TICKER™ expressions provide a unique technique for searching, extracting and/or monitoring information contained within embodiments of the system 100. FIG. 8 lists several examples of TOPIC TICKER™ symbols and their associated search terminology. For instance, if a client 150 is interested in querying with respect to the public company “SOUTHWEST AIRLINES”, the client could simply query using the TOPIC TICKER™ symbol LUV, which corresponds to SOUTHWEST AIRLINES, as shown in FIG. 8. The LUV TOPIC TICKER™ expression will search for the term “Southwest” within the same file document or normalized time slot as “airline” or “airlines”. Thus, the “+” sign used within the search logic represents a query asking that at least one of the search terms on either side of the “+” sign be contained within the same file or normalized time slot or frame. Further, the use of the parentheses “( )” symbols dictates a requirement that at least one of the terms contained within the symbol must be present in the observation to return a hit or tick associated with the particular TOPIC TICKER™ symbol. As will be understood, this method of searching is advantageous because it increases the chances that a given term will in fact be associated with the desired subject matter. For example, the term “southwest” may be referenced in an observation having nothing to do with SOUTHWEST AIRLINES, which would produce a false occurrence or tick of the term and would skew the results of the query. However, if the term “southwest” is coupled within the same time slot or file as “airline” or “airlines,” the chances are greatly increased that the particular observation is in fact referencing SOUTHWEST AIRLINES, thus producing a far more accurate output.

As illustrated in FIG. 8, the TOPIC TICKER™ symbols pool together a set of key words and/or strings of key words. As should be understood by one having ordinary skill in the art, the TOPIC TICKER™ symbols may be set by a system operator, or be customizable by the client 150 or user, or may even dynamically update based upon a recognition of particular couplings associated with given search terms. In an embodiment in which the TOPIC TICKER™ expressions are dynamically generated, when the system 100 detects the repetitive occurrence of two or more search terms or patterns of terms in a large number of common observations, then a TOPIC TICKER™ expression is created for these two or more terms or patterns. Thus, embodiments of the system 100 can change in response to the way terms or expressions are referenced in the world.

Additionally, the TOPIC TICKER™ expressions may include any number of search terms or commands in addition to the “+” and “( )” signs discussed above, including, but not limited to, “−” signs denoting that a certain term should not be contained within the same document or time slot as another term, “,” signs denoting an OR command, and even nested TOPIC TICKER™ expressions. In one embodiment, a special character is used to identify a TOPIC TICKER™ symbol that has been entered. For instance, a dollar sign “$” may be used to identify a TOPIC TICKER™ symbol. Accordingly, embodiments of the system 100 will recognize a TOPIC TICKER™ symbol over a regular search expression when the “$” is used.

Overall, the use of TOPIC TICKER™ symbols within queries in embodiments of the present invention allows for more efficient, dynamic, and accurate searching. As will be understood, because of the way the TOPIC TICKER™ symbols are constructed, false occurrences or ticks will be minimized because relational words are taken into account. In this way, TOPIC TICKER™ expressions are designed to think in the way that humans think—not in a robotic manner, but in a manner that takes into account words, expressions, and the overall context of an observation, and records occurrences of search terms in relation to the surrounding context and phrases.

Returning now to FIG. 6, if a query service request 610 includes a TOPIC TICKER™ symbol, then that symbol will be processed 618 to dereference the TOPIC TICKER™ symbol, including any nested TOPIC TICKER™ symbols. This dereferencing allows the system 100 to execute the particular query terms contained within the TOPIC TICKER™ symbol against the particular index 528. Additionally, dereferencing the TOPIC TICKER™ expression at this point in the query service component 600 allows for dynamic changing of the TOPIC TICKER™ symbols and related query expressions with an immediate realization of the change. After they have been dereferenced, the query expressions are parsed 620 to format executable queries. As previously mentioned, one embodiment of the present invention contains query expression language that supports conjunction (AND) using temporal and relative proximity, disjunction (OR) via lists, negation (NOT), grouping, and other search expressions.

Next, the query expression language is compiled into executable queries that are subsequently executed 622 against the index 528 associated with a specific query service 614. The queries are planned and segmented based on dependencies, which is the degree to which each program module relies on each other program module. Some queries may execute in parallel and have no dependencies. Alternatively, other queries require the output from another query to complete, and these queries are chained together and executed serially by the execute queries step 622. Regardless of whether they are chained together or not, all queries must execute before a response is returned to the caller (i.e. the query service client API 602 and, ultimately, the client 150). Accordingly, the queries are executed against the relevant observations, time slots, attributes, etc. for the particular index 528 based upon the request type in the query service request 610. The results of the query request 610 are grouped, ordered, and in some cases weighted according to request type. This grouping, ordering, and weighting comprises the process results step 626 of the query service component 600. Once processed 626, the query results are formatted and then serialized based upon the specific request type to build the query response 628. In one embodiment, some request types generate a large data set and network bandwidth, and thus the overall execution times are improved by compressing and transmitting the data at the build response step 628. Once built, the query service response 612 (which is identical to the query service federator response 606) includes the request/response type, an identifier for the request, and the resulting data.

As mentioned previously, a purpose of one embodiment of the present invention is to track the occurrence of search terms over a plurality of sources 110 either in virtually real-time or over a specified time period. The occurrence of a reference to one or more parts of a search expression, generally in the form of a TOPIC TICKER™ symbol, within a source 110 is referred to as a “tick.” In one embodiment, these ticks are what results from the execution of queries 622 against the index 528, and what is subsequently returned in the query service response 612, 606 to the query service client API 602 and further analyzed by other processes of embodiments of the invention. Additionally, a client 150 may wish to weight some sources 110 higher or lower than others, thus assigning more importance to one source over another. Accordingly, a response including ticks from a weighted source 110 may have a value higher or lower than “1”, and thus the running average and total number of ticks returned will be different from what is actually observed. For example, assume a client 150 wishes to track references to APPLE COMPUTERS. In this embodiment, assume APPLE is represented by the TOPIC TICKER™ symbol “AAPL” (corresponding to APPLE's NYSE symbol), and the related query expression:

(apple,aapl)+(shares,stock,computer,computers,electronic,electronics),ipod,imac,itunes.

Thus, if the word “apple” is referenced anywhere in the same document or time slot as “computer” or “electronic”, etc., then a tick will result. In this example, assume the source 110 in which the tick was registered was a CNBC television feed. In one embodiment, a tick is given a value of “1”. However, if a client 150 or system operator desires, they can weight sources 110 with different values. Thus, if the particular client 150 considers CNBC TV to be a less important source 110 than others, the client may assign CNBC TV a weighted value of 0.75. Accordingly, any ticks detected and reported from CNBC TV will only register a total value of 0.75 (tick value multiplied by weighted value), and thus will have less impact on overall averages and total reported tick values.

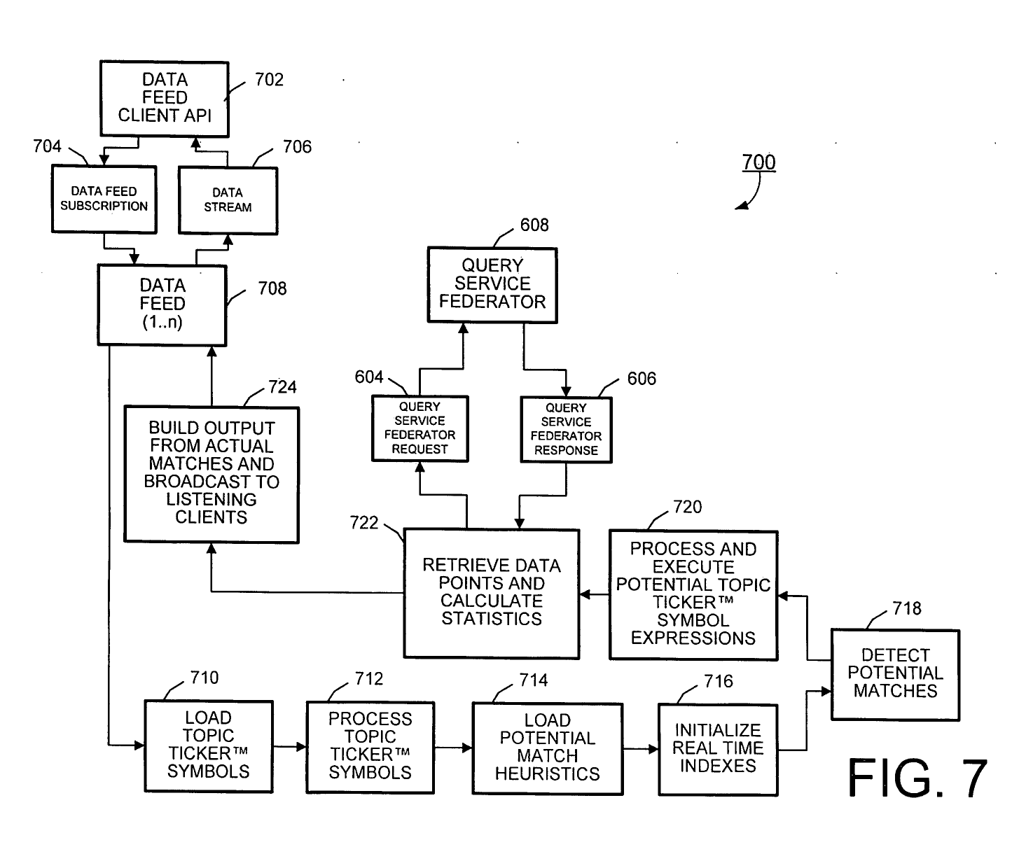

FIG. 7 is a flow chart illustrating operations associated with the client service component 700 according to an embodiment of the present invention. The client service component 700 shown in FIG. 7 contains functions and elements that provide clients 150 or outside users access to data or services within the system 100. The services and data are exposed to the client 150 in any number of ways, including via industry standards such as TCP/IP, HTTP, or SSL (Secure Socket Layer). Additionally, the data and services may be exposed or realized via client APIs, spreadsheet plug-ins, list or table generators, and any other mechanism capable of transmitting and presenting data.

Within the embodiment shown in FIG. 7, the data feed client API 702 is a client-side code that is installed on a client 150 computer or integrated into a larger client system. However, as will be understood by one of ordinary skill in the art, the data feed client API 702 may include any API or system that allows connection to and interaction with the overall system 100. In one embodiment, the data feed client API 702 encapsulates the data feed component 708, performs authentication with the system 100, starts sessions, begins information feeds, provides call backs when new data has arrived, and many other related functions. In one embodiment, the data feed client API 702 allows system operators and software engineers to develop data feed specific or client-specific applications. In this way, embodiments of the invention may be tailored to fit each client's needs. Additionally, one embodiment includes a default API if a client 150 desires a basic, non-customized API.

The data feed subscription component 704 defines the particular subscription to the services provided by embodiments of the system 100 for a particular client 150. More specifically, the data feed subscription 704 indicates the desire to receive one or all of a specific type of feed and related information. The subscription 704 is associated with a registered and authenticated client 150 or user, whether it is an individual, company, government agency, or any other potential user or group of users. The subscription 704 indicates, among other things, the particular feed identifier or identifiers, data points desired (e.g. ticks, statistics, indicators, alerts, etc.), and particular output formats (e.g. XML, tab delimited, etc.). A “feed identifier” indicates a particular output feed related to a particular subject matter. A particular feed associated with a feed identifier may include certain TOPIC TICKER™ symbols, or certain sources 110, particular search expressions, etc. For instance, a client 150 may only be interested in references to FORTUNE 500 companies, and thus the client 150 or system operator may create a feed identifier related only to search expressions and sources associated with FORTUNE 500 companies. As an example, the FORTUNE 500 feed identifier may only include sources 110 relating to financial or business discussions, and may only incorporate search expressions and TOPIC TICKER™ symbols containing the name of the companies. As will be understood by one of skill in the art, a feed identifier may be created within embodiments of the present invention for virtually any topic or subject, such as political candidates, publicly traded companies, war, sports, or anything else.

Additionally, different feeds may correspond to different subscription costs for the end user or client 150, and thus a particular client can customize a feed based solely on his or her needs.

Still referring to the embodiment shown in FIG. 7, the data feed component 708 recognizes which data feed subscription 704 the particular client 150 has, and retrieves information relating to that subscription 704. The data feed 708 also acts as a “push” interface for providing real-time information once the client service component 700 has located and retrieved the desired information. Generally, data feeds 708 allow client applications or systems to subscribe to a specific data feed (corresponding to a feed identifier discussed above), and, as TOPIC TICKER™ symbols or other search expressions are mentioned or discussed within observations, corresponding data regarding the mentions or discussions are returned to the client 150. Non-limiting examples of such data include the source 110 in which the TOPIC TICKER™ symbol or search term was observed, how many references have been made to the search expression in the past minute, or hour, etc., a current moving average of occurrences over a specified time period, a current moving standard deviation corresponding to the moving average, indicators, alerts, lists, and other similar data. Also, as shown in FIG. 7, embodiments of the present invention may include one data feed 708 or n data feeds depending on the number of subscribing clients, sources 110, etc.

Once the client service component 700 has detected the particular subscription 704 at issue, the client service component 700 loads the TOPIC TICKER™ symbols, expressions, and all related attributes corresponding to that subscription. Again, in embodiments of the present invention, the subscriptions 704 are completely customizable, so the related TOPIC TICKER™ symbols and nested TOPIC TICKER™ symbols, and all other search expressions, must be loaded 710 and processed 712 for the particular data feed subscription 704. The TOPIC TICKER™ symbols must be processed 712 by dereferencing the symbols and all nested symbols and replacing the TOPIC TICKER™ symbols with unraveled query expressions. This TOPIC TICKER™ symbol processing component 712 functions in the same manner as the process component 618 contained in the query service component 600, and allows for dynamic changing of TOPIC TICKER™ symbols and immediate realizations of the change.

According to one embodiment, once the TOPIC TICKER™ symbols have been processed and dereferenced 712, potential match heuristics are loaded 714 based upon the dereferenced TOPIC TICKER™ expressions. In one embodiment within the match heuristics component 714, vectors are created for each TOPIC TICKER™ symbol, wherein the vector includes all the tokens in the expressions or sub-expressions within each TOPIC TICKER™ symbol. This vector is used when an index 528, preferably a real-time index, merges new observation content into the system 100. Once this merging occurs, a “hit” vector is maintained and compared to the “potential match” vector to determine when a potential match is detected. A “potential match” refers to the possible occurrence of a search term within an observation.

After the respective vectors have been created and maintained, real-time indexes are initialized 716. In one embodiment, the real-time indexes and hit vectors are constantly changing in response to new observations, whereas the potential match vectors only change in response to an updated TOPIC TICKER™ symbol, new TOPIC TICKER™ symbol, or new search expression. The real-time indexes are based on the same indexes 528 used by the query service component 600. By reusing the core structures and algorithms of the indexes 528, it is possible within embodiments of the present invention to execute query expressions (associated with their respective TOPIC TICKER™ symbols) against a smaller set of data. This smaller set of data may correspond to observations collected in the past minute, or 5 minutes, or 10 minutes, etc. As will be understood, virtually any timeframe is possible for these real-time indexes. Also, the real-time indexes contain additional data structures, such as the “hit” and “potential match” vectors described above. These real-time indexes are “flushed” (i.e. memory is deallocated) on a regular basis (for example, every minute, or every 5 minutes, etc.), and when a potential match of a search term is confirmed to be an actual match, that tick, as well as prior tick data, is held in memory for a period of time. For example, one embodiment may maintain a running total and average of the past 7 days of one-minute tick data, assuming the real-time index is flushed every minute. Thus, the real-time indexes associated with the embodiment will contain a constantly-updating memory of the past 7 days of ticks. As will be understood, the flush periods, as well as the running totals and averages, may be varied by the client 150 or system operator. Additionally, in one embodiment, one or more real-time indexes are loaded locally in the data feed's 708 process space, and this list of indexes is declaratively controlled.

In one embodiment, once all the tokens associated with one or more expressions or sub-expressions associated with a TOPIC TICKER™ symbol have been observed during the initialization and merging of the real-time indexes 716 and query service component indexes 528, the respective TOPIC TICKER™ symbol is added to a list of potential TOPIC TICKER™ symbol matches. This set of TOPIC TICKER™ symbols is further executed against the “local” (i.e. in process) real-time indexes to detect potential matches of TOPIC TICKER™ symbol expressions 718. In one embodiment, this list of potential TOPIC TICKER™ symbols is executed against the local real-time indexes because the potential match heuristics do not take into account any included operators (e.g. negation, conjunction, disjunction). According to one embodiment, this process of executing potential TOPIC TICKER™ symbol expressions 720 is simplistic and fast, and merely looks for matches of one or more expressions or related sub-expressions.

As shown in the embodiment of FIG. 7, after the potential matches of TOPIC TICKER™ symbol expressions have been confirmed as actual matches against the real-time indexes, the query service federator 608 is called with the matched TOPIC TICKER™ symbols to retrieve corresponding data sets 722. In one embodiment, this corresponding data retrieved via the query service federator 608 is historical data related to a particular TOPIC TICKER™ symbol, group of TOPIC TICKER™ symbols, or other search expressions. In one embodiment, the retrieved data sets are used to build statistics, indicators, and alerts for delivery to the client 150. However, as will be understood by one of skill in the art, the retrieved data may be used by and/or displayed to the client 150 or user in any number of ways.

Additionally, in one embodiment, the data feed 708 space maintains a running total and/or average of retrieved data. This running total and/or average may be data corresponding to virtually any time period. For example, the data feed 708 may maintain 7 days worth of one-minute data for each TOPIC TICKER™ symbol or search expression that has been matched (an actual match). Using a one-minute time slot in this way supports the running total without having to return to the query service component 600 after the initial data call. Additionally, maintaining the running total of tick data in the data feed 708 allows any related statistics to be recalculated “on the fly” when an actual match event occurs. This recalculation is highly advantageous when monitoring rises and falls in TOPIC TICKER™ symbols or other search expressions across a plurality of sources 110 in virtually real-time.

Once all points have been retrieved by the query service federator 608, the client service component 700 builds outputs from actual matches and broadcasts those outputs to listening clients 724. In one embodiment, the outputs are formatted and created oil a per-user or per-connection basis relative to the corresponding data feed subscription 704. For example, one client 150 may want his or her data stream 706 displayed in XML format, whereas another may desire a tab-delimited format. After the data has been formatted, it is placed in a thread queue and broadcast to listening clients 150 via the data feed 708 and data stream 706. The data stream 706 transfers data from the data feed 708 to the data feed client API 702. The particular data transferred is a function of the data feed subscription 704 of the particular client 150, but typically includes ticks, a plurality of statistics, indicators of rises and falls in tick averages or standard deviations, alerts, and many other kinds of data. In one embodiment, the data stream 706 includes connection protocols such as TCP/IP, UDP, and other similar protocols.

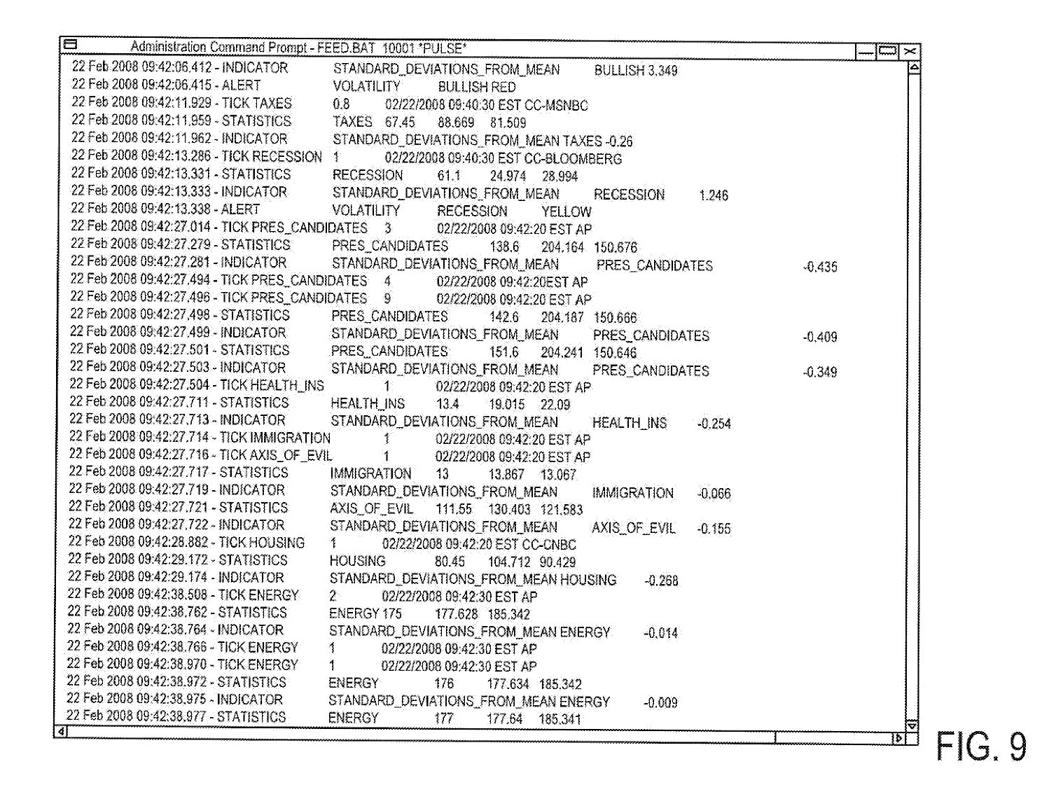

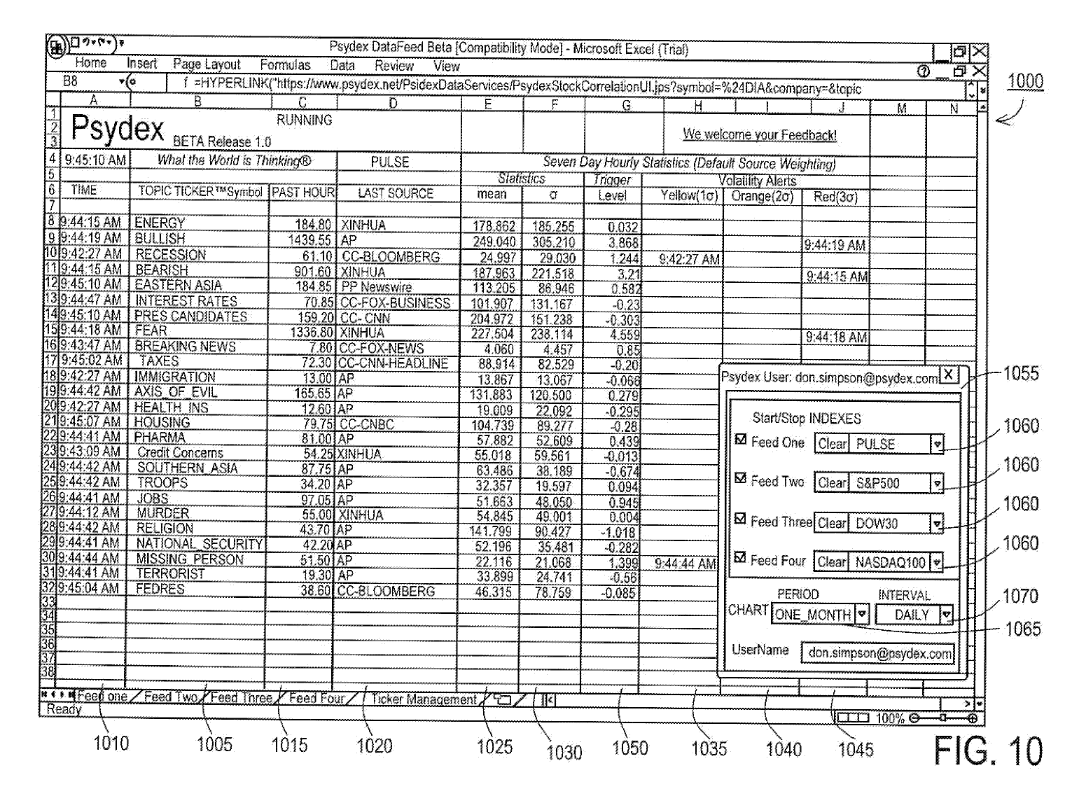

FIGS. 9-12B illustrate sample outputs 140 from the logical system architecture 300 and system 100 as a whole according to various embodiments of the present invention. Referring first to FIG. 9, a screen shot of a sample data feed 708 is shown at a particular moment in time. This data feed represents the raw data as output by an embodiment of the overall system 100. According to one embodiment, this data feed output constantly updates as new ticks corresponding to a particular subscription 704 are detected. This raw data feed 708 is typically converted into a more easily readable format, such as the spreadsheet plug-in shown in FIG. 10. The raw data feed 708 includes and outputs any desired data related to ticks associated with TOPIC TICKER™ symbols or other search expressions for a particular subscription 704, and may be customized to only present limited data items (such as averages of tick counts), or, alternatively, to present a wide array of data and related statistics.

FIG. 10 is a screen shot of a sample output 1000 to a client 150 based on a raw data feed 708, like the feed shown in FIG. 9. The output shown in FIG. 10 interprets and displays the data from FIG. 9 in a more user-friendly fashion. In the example shown in FIG. 10, the statistics represented are running hourly statistics for the past 7 days of tick data associated with a selected set of TOPIC TICKER™ symbols, and all related statistics and items are continually updated in virtually real-time. Column 1005 represents the particular TOPIC TICKER™ symbols being tracked by embodiments of the output 1000. In some embodiments, the list of TOPIC TICKER™ symbols shown in column 1005 may be any TOPIC TICKER™ symbols within the client's 150 subscription 704 that have experienced a tick since the spreadsheet was opened. As discussed previously, the user or client 150 may define which TOPIC TICKER™ symbols or query expressions he or she wishes to monitor, and thus any TOPIC TICKER™ symbol or search terms may be tracked by an output similar to output 1000. The time column 1010 shows the last time a tick was registered for an associated TOPIC TICKER™ symbol. In the embodiment shown, the times in column 1010 are continually updating in virtually real-time as ticks from given observations are reported. Column 1015 represents the number of times a tick related to a given TOPIC TICKER™ symbol was emitted from any of the selected sources 110 over the past hour. The time frame in column 1015 (the past hour, in the example shown) may be set by the user, and thus can be virtually any time frame the user desires (such as past 10 minutes, past day, etc.). Column 1020 displays the last source 110 from which a tick was detected. In this way, the client 150 can easily track the sources 110 discussing the ticks as the ticks are registered to determine if the topic or subject matter is being discussed at a particular volume in one source 110, or across many sources.

Still referring to the embodiment shown in FIG. 10, column 1025 shows the hourly mean or average number of ticks for each TOPIC TICKER™ symbol over the past 7 days (7-day hourly average). As mentioned, the one-hour and/or 7-day time frames are merely representative time frames, and virtually any other time, frames may be used for calculating data. Column 1030 represents the hourly average of standard deviations of ticks as related to the mean for the past 7 days in the embodiment shown. The standard deviation can be an important value for clients 150 because the client is able to view when tick occurrences are rising high above or falling far below the corresponding average. Along those lines, embodiments of the present invention may incorporate volatility alerts, displayed in columns 1035, 1040, and 1045 in the embodiment in FIG. 10. For instance, a yellow volatility alert (column 1035) may indicate when a particular TOPIC TICKER™ symbol has experienced related ticks at least one standard deviation above or below the mean for that TOPIC TICKER™ symbol. The particular volatility alert may flash when a particular standard deviation is breached, or it may show the time of the last tick that caused the alert, or it may alert the client 150 in any number of ways that the ticks for that TOPIC TICKER™ expression are experiencing a volume one standard deviation either above or below the mean. Similarly, in the embodiment shown, column 1040 represents a volatility alert when a TOPIC TICKER™ symbol has experienced ticks at least two standard deviations above or below the mean. Column 1045 represents a volatility alert when a TOPIC TICKER™ symbol has experienced ticks at least three standard deviations above or below the mean. As will be understood, the volatility alerts could be based on any number of standard deviations, or something else entirely. For example, in one embodiment an alert is set when the number of ticks recorded for a particular time frame doubles the average. Another embodiment signals an alert when the mean is tripled. Essentially, an output 1000 may be used to track ticks and running data with virtually any statistical measure.

Further, the trigger level shown in column 1050 in FIG. 10 is a running display of the current standard deviations from the mean for each TOPIC TICKER™ symbol. This column 1050 prominently displays to the user or client 150 exactly how far the current tick count 1015 is above or below the mean (in terms of standard deviation). Additionally, as will be understood to one having ordinary skill in the art, the client 150 can link certain triggers to the output 1000 that initiate actions outside the system 1000. For instance, a stock trader may want to buy or sell a certain stock when that stock is discussed at certain levels in the media (across varying sources 110). Assume, for example, the trader is interested in tracking the TOPIC TICKER™ symbol for APPLE COMPUTERS. The trader may have an embodiment of the present invention linked to his or her own personal trading system, such that when the trigger level 1050 for APPLE COMPUTERS reaches a certain value, the trader's own trading system will buy or sell a certain number of shares of APPLE stock. For instance, the trader may have a command set to buy 500 shares of APPLE if the TOPIC TICKER™ symbol for APPLE experiences tick counts outside 3 standard deviations from the mean. In this way, the trader will be trading on the volatility of discussions in the market about APPLE, and assuming the actual APPLE stock will rise or fall accordingly. Furthermore, because the trigger level 1050 is set to buy or sell automatically, the trader will buy or sell the given stock virtually instantaneously as the particular stock is discussed in high or low volumes across the world.

Moreover, some embodiments of the invention include output control components 1055 that enable the client 150 to quickly and easily update or change the output settings.

As shown in the embodiment, the user can change the particular feed 1060, the time period 1065 being monitored (i.e. how far back the averages are calculated), and the interval 1070 (i.e. number upon which mean, standard deviation, etc. is based). As will be understood, the output control component 1055 may include a plurality of sources and features, and is not limited to the elements shown in the embodiment. Further, in one embodiment, regardless of the particular feed selected, the user or client 150 may be alerted to “hot topics,” which are TOPIC TICKER™ symbols experiencing the highest current tick counts system-wide. For instance, a user may not receive the TOPIC TICKER™ symbol for APPLE COMPUTERS within his or her subscription 704, but the user may still be alerted if the TOPIC TICKER™ symbol for APPLE COMPUTERS is experiencing ticks or hits at an uncharacteristically high volume. As will be understood, these hot topics may be set by the system operator corresponding to, for instance, the 10 most active TOPIC TICKER™ symbols (receiving most ticks) throughout the system 100, or any TOPIC TICKER™ symbol experiencing tick counts more than 5 standard deviations outside of the mean, or any other delimiter for alerting users of certain highly-active TOPIC TICKER™ symbols.

Importantly, the output 1000 shown in FIG. 10 is not limited by the statistics shown. As will be understood by one having ordinary skill in the art, virtually any statistics may be calculated using the tick data. Additionally, the results and statistics may be presented in a variety of outputs, including, but not limited to, a constantly-updating graph or chart, a scatter plot, or may even be represented by varying sounds, colors, or any other presentation methods.

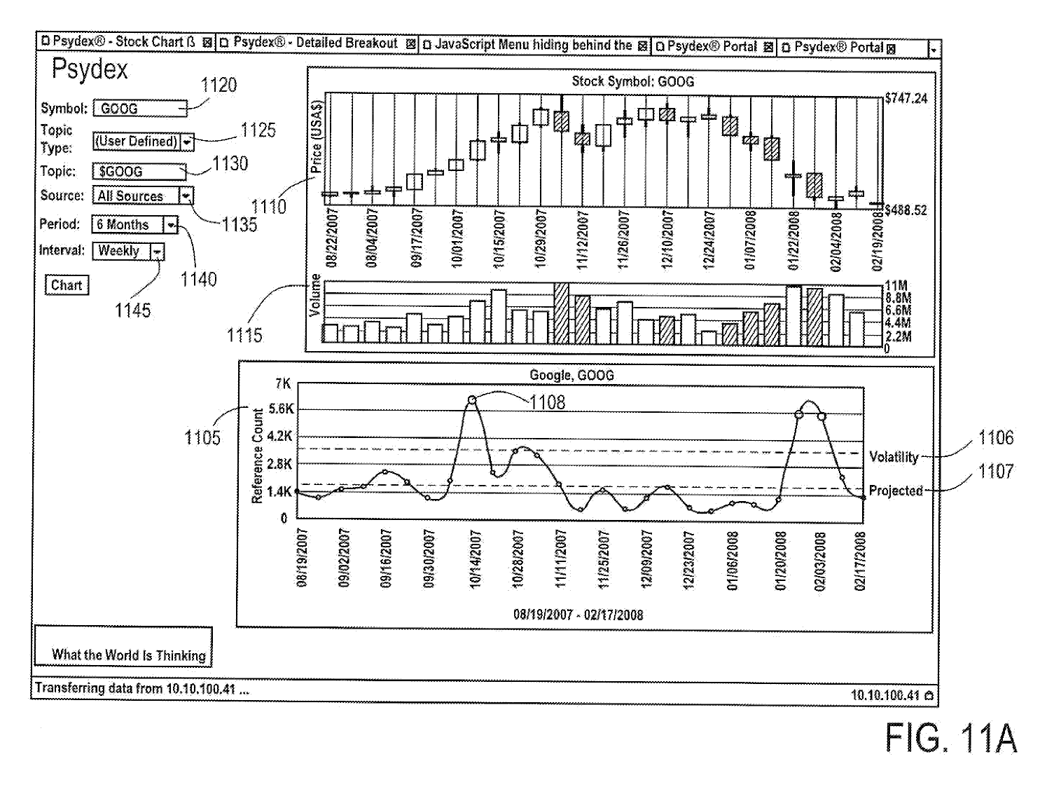

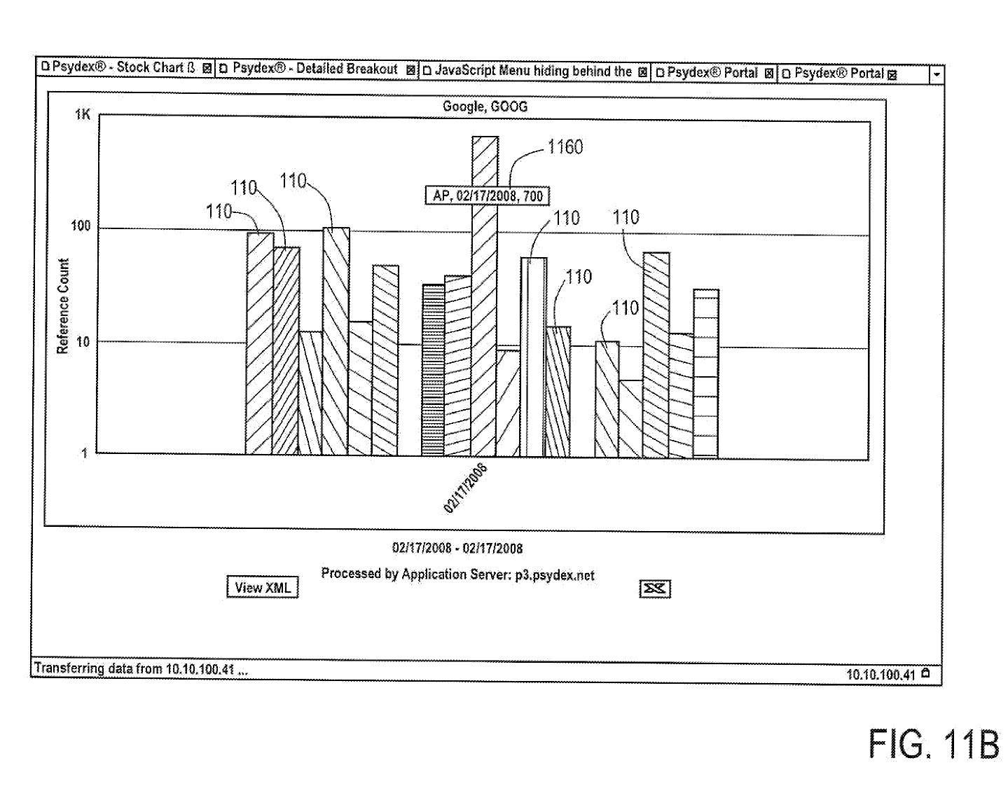

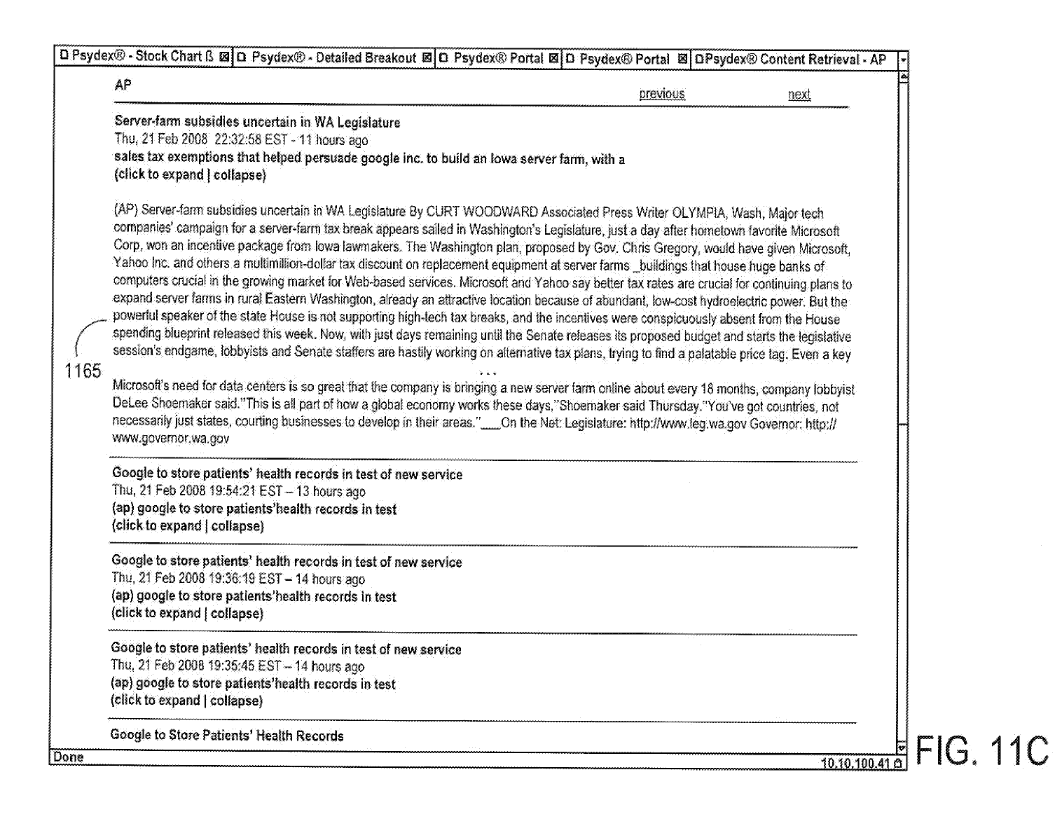

FIG. 11A is a sample screen shot of a display for a static query for a particular time period. The display includes a tick count plot 1105, stock price chart 1110, and total stock volume traded chart 1115 for a particular TOPIC TICKER™ symbol over a particular time period according to an embodiment of the present invention. The embodiment shown in FIG. 11A is especially useful for analyzing stock trends and anticipating future movement of stocks based upon relevant tick counts, and thus the embodiment would be extremely beneficial to stock traders, investment bankers, and financial analysts, to name a few. The embodiment includes search input fields for the user or client 150 to input a particular stock symbol 1120, or a user-defined search topic type 1125, a topic 1130 (which can be a query expression or TOPIC TICKER™ symbol), a particular source 110 or grouping of sources 1135, the time period 1140 over which to plot the data, and the interval 1145 for plotting discrete data points. Once a user has input the desired search and plot criteria, the charts 1105, 1110, and 1115 are generated by the system 100 by executing queries in the logical system architecture 300 as described in detail above.

As shown in the embodiment of FIG. 11A, the user has input the term “$GOOG” into the topic field 1130, denoting the user wishes to search the TOPIC TICKER™ symbol related to GOOGLE (as indicated by the “$”). However, if a user or client 150 does not wish to use a specific TOPIC TICKER™ symbol, or does not know if a specific TOPIC TICKER™ symbol exists for the client's 150 desired search criteria, the client can enter a different search term of the client's choosing into the topic field 1130. In one embodiment, the user can dynamically build topics and search terms by entering a stock symbol into the symbol field 1120 and a related topic type 1125. For example, a user may want to display ticks related to IBM's competitors, but there may be no related TOPIC TICKER™ symbol for that subject matter. Thus, the user could input “IBM” (stock symbol for IBM) into the symbol filed 1120 and “competitors” into the topic type field 1125, and the resulting topic and displays would return references to IBM's competitors.

Along those lines, embodiments of the system 100 can cluster or suggest semantically related concepts with little input. For example, a user could input 4 or 5 related terms into the topic field 1130 shown in FIG. 1 IA, and the system 100 can suggest, based on relational indexed data, highly correlated terms and phrases to enable the user to better search for a particular topic or subject. Or, the system 100 may suggest a particular TOPIC TICKER™ symbol on point to the user's search terms, or even may construct a new TOPIC TICKER™ symbol related to the expressions entered by the user. In this way, embodiments of the invention are dynamically generating new TOPIC. TICKER™ symbols or search expressions as needed by clients 150.

The tick count chart 1105 shown in FIG. 1 IA according to an embodiment of the invention plots tick data according to a particular time interval over a defined time period for a given TOPIC TICKER™ symbol or search expression. As shown, references to the particular TOPIC TICKER™ symbol or search expression within the selected sources 1135 may rise and fall over the selected time period 1140. Also, the average volatility 1106 and projected tick occurrences 1107 are plotted on the tick count chart 1105 in the embodiment shown. These volatility measures 1106 and projected tick counts 1107 are calculated by an algorithm based upon the returned data. The stock price 1110 and total volume of stock traded 1115 are plotted for the same time period 1140 as the tick count chart 1105, and the three charts may be compared visually, or via some additional analysis tool. Additionally, as will be understood, the stock chart 1110 and tick count chart 1105 do not have to be plotted over the same time period, for instance, if a user or client 150 wants to analyze long term effects on a stock price after particular tick count peaks and valleys.

Moreover, in the embodiment shown in FIG. 11A, a user or client 150 may scroll over (via a mouse, touch-screen, or other interactive user display) and select a particular point 1108 on the tick count chart 1105 to see a breakout of sources 110 and respective ticks for each source for a certain date or time period. For instance, FIG. 11B is a screen shot of an example window showing sources 110 and related ticks. The sources 110 may be color-coded and referenced to a key or legend to create an easy-to-view visual breakdown of sources 110 according to one embodiment. Also, the client 150 may scroll over each particular source 110 to view a pop-up window 1160 illustrating the source name, the exact number of ticks for that source 110 for the time period, the particular date of the last occurrence of a tick for that source, or any other information related to the source 110. The graph shown in FIG. 11B is a bar graph of sources and associated ticks for a particular day corresponding to a day plotted in the tick count chart 1105 in FIG. 11A. However, as will be understood to one having ordinary skill in the art, any time period, type of display, or display characteristics are possible for showing data related to particular sources and/or ticks, such as a pie chart, list, line graph, or any other delivery mechanism.

Furthermore, if a user wishes to drill down even further into the output tick data, then the user can click on a particular source 110 shown in FIG. 11B, and a listing of the actual observations recorded for that source 110 may be displayed, as shown in FIG. 11C, according to embodiments of the present invention. In the embodiment shown, each observation for that source 110 for the selected time period (hour, day, week, etc.) is listed according to the title of the observation, the time it was recorded, and many other features. Additionally, in one embodiment, a user can click on the observation to expand the observation 1165 such that the user can immediately view exactly what was said about the TOPIC TICKER™ symbol or search expression that gave rise to the tick. In this way, the user or client 150 can view whether or not certain observations are discussing the TOPIC TICKER™ symbol or search expression in a positive or negative manner, which may influence the user or client's decision on whether to buy or sell stock, take certain actions, etc.

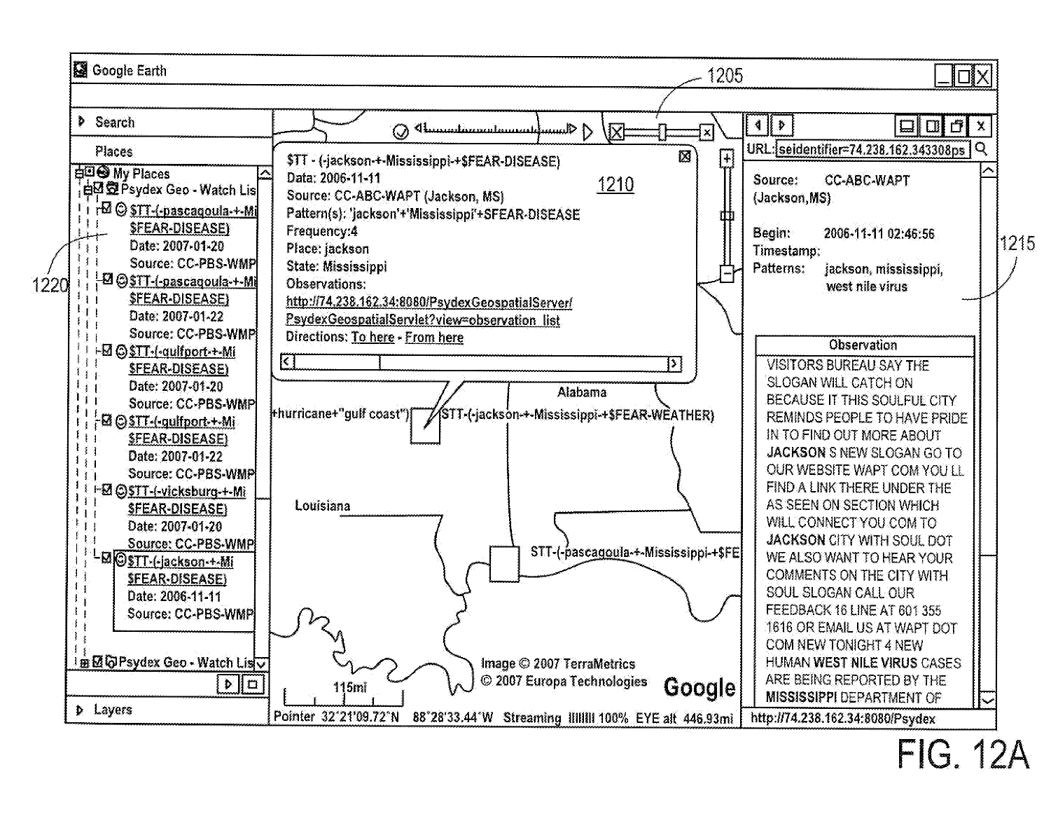

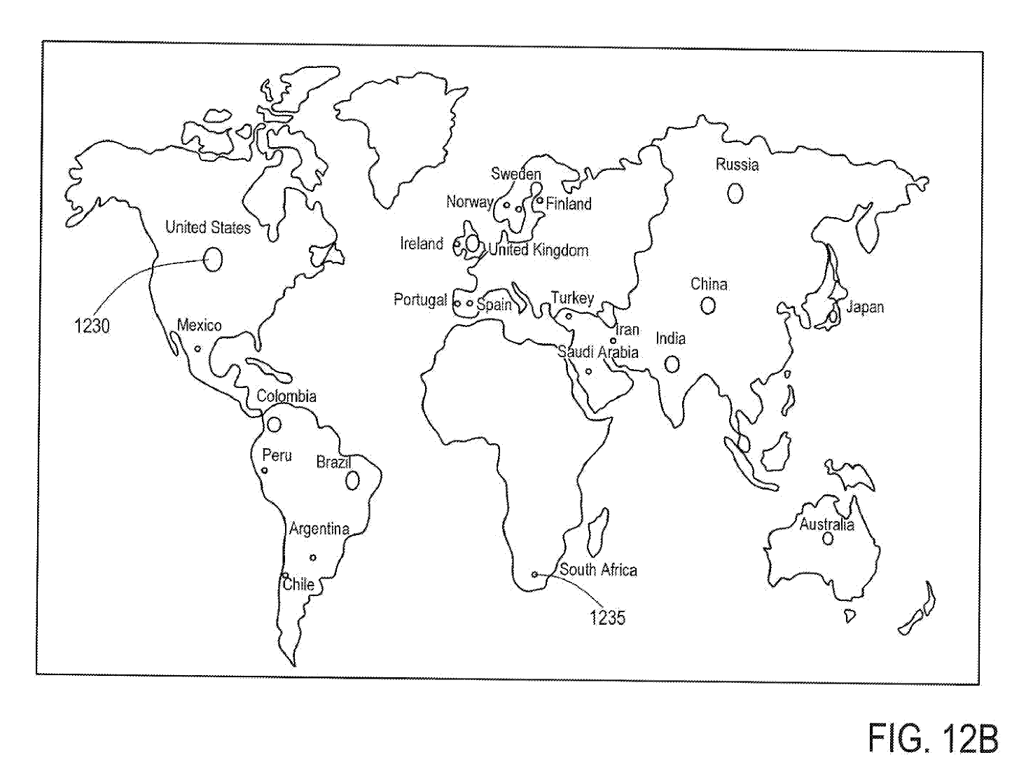

In further embodiments of the present invention, heat maps and geospatial views of the data and tick output from the system 100 may be created, as shown in FIGS. 12A and 12B from recorded geospatial data indexed by the system 100. Referring first to FIG. 12A, a screen shot of a sample geospatial view is shown according to one embodiment of the present invention. In the embodiment shown, a central map window 1205 is displayed for a particular region of the user or client's 150 choice. As will be understood, this displayed region may be an entire country, or state, or city, or town, or even a neighborhood. Virtually any area including sources 110 may be viewed by the map window 1205. In the embodiment, as a particular tick related to the client's data feed subscription 704, or to a TOPIC TICKER™ symbol or search expression, is detected by the system 100, a corresponding icon or symbol flashes on the screen within the map window 1205. A user or client 150 may scroll over the icon or symbol to see a pop-up window 1210 that displays information about the particular tick, such as the date and time of the tick, the source 110, the TOPIC TICKER™ symbol or search expressions detected, the exact location of the tick (latitude and longitude coordinates, address, city, state, etc.), a link to the particular observation referencing the TOPIC TICKER™ symbol or search expressions, and any other data related to the tick or associated statistics the user desires.

Further, in the embodiment shown in FIG. 12A, an observation window 1215 displays the specific observation for the tick reference selected, and highlights the terms within the observation that caused the tick. A user or client 150 may view the entire observation, or only a portion of the observation, depending on the user's preferences. Also, the observation window 1215 may include information related to the observation, such as the source 110, timestamp when the observation began, patterns within the observation, number of references or ticks stemming from an observation, or any other information related to the observation. In addition, a tick watch window 1220 is implemented in some embodiments for displaying ticks associated with the particular region in a list form. In this way, the user may easily view the ticks as they occur, or during a specified time period, and click on the ticks to view where on the map the tick emanated from, and see details related to the tick.

FIG. 12B illustrates a heat map according to an embodiment of the present invention. A heat map can be used to show which regions of a given area are discussing TOPIC TICKER™ symbols and related query expressions more than others, and thus producing more ticks as compared to other regions. For example, in the map shown, the United States has a larger dot 1230 than South Africa 1235, which, in this embodiment, symbolizes that more ticks for the particular TOPIC TICKER™ symbol or search expression are originating in the United States. As will be understood to one of skill in the art, any number of indicators may be used to signal a higher or lower volume of ticks within a given area, such as a change in color or pattern, a flashing signal, etc. As will additionally be understood, while the embodiment shown in FIG. 12B illustrates a map of the entire world, virtually any region may incorporate a heat map display, such as a particular country, city, town, etc. The heat map is beneficial, for instance, if a user or client 150 was primarily interested in discussion of a certain topic centered around one region or principality. In this way, the client 150 can quickly and easily view which parts of the given region are discussing the search expression in more or less volume, based on the source 110 from which the observations and related ticks stem.

As previously mentioned, although the observations observed within embodiments of the system 100 do not necessarily start off as text, the source information is converted to text. However, it will be appreciated that embodiments of the present invention are not limited to working with text-based observations only. The various aspects and operations of embodiments of the invention described above may easily be applied to graphic elements, audio files, video files or any other file type, protocol, media, etc. that can be analyzed in such a manner so as to consistently identify its presence in an observation. Thus, although the files and streams are described in reference to an embodiment as including words separated by spaces, it should be appreciated that the present invention would equally apply to any of a variety of content with any type of delimiter or simply using patterns to delimit the various elements of the observation.

Moreover, in some embodiments, sentiment analysis may be performed on an output of the system 100. Sentiment analysis refers to constructing lists of words and/or phrases that connote positive and negative sentiment around TOPIC TICKER™ symbols or other search expressions. Embodiments of the system may record and store positive and negative words surrounding the TOPIC TICKER™ symbols or search expression, such as “good”, “bad”, “rise”, “fall”, “bull”, “bear”, etc. Accordingly, the associated “sentiment” may be reported with a tick or grouping of ticks in a separate output or incorporated into any of the outputs described in FIGS. 9-12B. This sentiment analysis enables a user of the system 100 to more appropriately act on given query results and outputs of information.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for organizing information to support querying of the information within a computer system, comprising the steps of:
receiving data within the computer system, wherein the data includes a text portion and at least one temporal attribute;
tokenizing the text portion of the data to identify a plurality of tokens within the text portion;
defining a plurality of discrete time slots, each having a time period;
associating the at least one temporal attribute of the data with one of the defined time slots; and
indexing the tokenized text portion of the data with the associated time slot to enable searching and retrieval of the tokenized text portion as a function of the time slot.

2. The method of claim 1, wherein the data is an electronic text file having a beginning and an end.

3. The method of claim 2, wherein the electronic text file has one temporal attribute associated therewith.

4. The method of claim 1, wherein the data is one or more packets of a stream of packets.

5. The method of claim 4, wherein a beginning and an end of the stream of packets is defined by the time slot.

6. The method of claim 1, wherein the at least one temporal attribute includes a timestamp indicating the origination date and origination time of the data.

7. The method of claim 1, wherein the tokenized text portion of the data and the associated time slot are indexed in random access memory (RAM).

8. The method of claim 1, wherein the tokenized text portion of the data and the associated time slot are indexed in a database.

9. The method of claim 1, wherein the data is obtained from a data source.

10. The method of claim 9, wherein the data source includes one or more of an electronic transmission, electronic broadcast, Internet posting, Internet message board, electronic news feed, blog, closed caption feed, and electronic document feed.

11. The method of claim 1, wherein the step of tokenizing further includes separating the text portion of the data into one or more categorized blocks of text and assigning meaning to the one or more categorized blocks of text.

12. The method of claim 1, wherein the data includes a spatial attribute, and further comprising the steps of:
associating the spatial attribute of the data with one of a predefined spatial parameters; and
indexing the tokenized text portion of the data with the associated one of the predefined spatial parameters to enable searching of the tokenized text as a function of the predefined spatial parameters.

13. The method of claim 12, wherein the spatial attribute includes latitude and longitude coordinates corresponding to a physical location from which the data emanated.

14. The method of claim 12, wherein the spatial attribute includes an address, town, city, state, country, zip code, or any combination or portion thereof, corresponding to the physical location from which the data emanated.

15. The method of claim 12, wherein the tokenized text portion of the data, the associated time slot, and the associated spatial parameter are indexed in random access memory (RAM).

16. The method of claim 12, wherein the tokenized text portion of the data, the associated one of the plurality of discrete time slots, and the associated one of the predefined spatial parameters are indexed in a database.

17. The method of claim 1, wherein the data further includes metadata attributes, including one or more of a title, headline, subject, author, publisher, category, publish date and publish location.

18. The method of claim 1, further comprising the steps of:
receiving a query request within the computer system, wherein the query request includes specific search criteria;
searching the plurality of discrete time slots according to the specific search criteria; and
returning an output in response to the search.

19. The method of claim 18, wherein the specific search criteria includes one or more of search expressions, start time, end time, an aggregation interval, data source, and any combination thereof.

20. The method of claim 19, wherein the aggregation interval comprises a predefined time period against which to search.

21. The method of claim 19, wherein the search expressions comprise at least one of a keyword, phrase, term, number, boolean command, and any combination thereof.

22. The method of claim 18, wherein the output comprises any tokenized text portions of the data identified while searching the plurality of discrete time slots.

23. The method of claim 18, wherein the output comprises a graph or chart.

24. The method of claim 18, wherein the output comprises a data feed.

25. The method of claim 18, wherein the output comprises statistical analyses of occurrences of the tokenized text portion of the data within the plurality of discrete time slots to the specific search criteria.
